(19) United States
(12) Patent Application Publication
(10) Pub. No.: US 2022/0366336 A1
(43) Pub. Date: Nov. 17, 2022

(54) FLEET OPERATIONAL ASSESSMENT BASED ON EXTRAPOLATION OF GEOLOCATION DATA

(71) Applicant: Route4Me, Inc., Florida, FL (US)

(72) Inventors: Dan Khasis, Tampa, FL (US); George Shchegolev, Tampa, FL (US); Josh Haims, Tampa, FL (US)

(21) Appl. No.: 17/745,824

(22) Filed: May 16, 2022

Related U.S. Application Data
(60) Provisional application No. 63/188,480, filed on May 14, 2021.

(51) Int. Cl. G06Q 10/06; G08G 1/00; G01C 21/34

(52) U.S. Cl. CPC G06Q 10/06311; G08G 1/20; G01C 21/3453

(57) ABSTRACT

Telematics data, including geolocation data, may be collected, monitored, measured, and/or generated by one or more processors communicatively coupled with memory and associated with a mobile, machine, and/or vehicle device. Telematics data may also be collected from one or more external vendors. Geolocation data pertaining to the mobile, machine and/or vehicle device may be analyzed to derive valuable information on the presence, dwell times, and movements of human beings. For example, a rate of human beings, such as, e.g., the cars in which they are driving or riding, traversing an area at specific times of day and days of the week can be inferred. In some cases, this information may also be used to plan and adapt highway systems, construction plans, and business plans. Significant reductions in vehicle emissions can be achieved, congestion can be limited, safety can be enhanced, and travel times reduced by helping commuters and other drivers choose uncongested routes to their destinations.

### CLAIMS OF PRIORITY

This patent application claims priority from:
(1) U.S. provisional patent application No. 63/188,480, entitled ‘Fleet operational assessment based on extrapolation of geolocation data’ filed on Mar. 14, 2021.

The application is incorporated by reference herein in its entirety.

### FIELD OF TECHNOLOGY

This disclosure relates to measuring and assessing operations of fleet travel data from global positioning system (GPS) devices.

### BACKGROUND

A vehicle management system may be used to assist in planning and operating routes for a fleet of human-operated and/or autonomous machines, including vehicles of different types, such as, e.g., flying drones, ocean drones, light-duty or heavy-duty, gas, hydrogen, or electric, as well as of different makes, models, or model years. The vehicles in a fleet may be used to perform a variety of tasks that may depend, in-part, on the types of vehicles or makes, models, or model years. A user or administrator of the vehicle management system may monitor vehicle locations, vehicle routes of the fleet, and may access information about an operation of the fleet via a user interface, an application programming interface (API), and etc.

Global positioning system (GPS) devices communicate with satellites to determine the precise location of, e.g., an on-board vehicle device or a mobile device, and are commonly used in navigation and route guidance systems. Geolocation data can serve as proxies for geolocations of human beings. By determining the geolocation of mobile, machine and/or vehicle devices at specific times, storing this time-associated geolocation data in a data store, and analyzing the geolocation data, a variety of useful information can be generated. However, conventional techniques in current practice are not able to monitor or analyze large amounts of data, e.g., big data.

The widespread use of motor vehicles for both personal and work related activities places millions of vehicles on roads each day with their operation being largely unmonitored. Unmonitored vehicles can lead to a variety of adverse issues and problems, including, for example, abusive usages, driving-safety issues and operational inefficiencies.

### SUMMARY

Telematics data, including geographic location data, may be collected, monitored, measured, and/or generated by one or more processors communicatively coupled with memory and associated with a mobile, machine, and/or vehicle device. Telematics data may also be collected from one or more external vendors. The telematics data may include various metrics that indicate the direction, speed, and/or motion of the device in which the data is associated. Direction may be relative to points on a fixed compass, such as cardinal points, e.g., north, south, east and west, or intermediate directions, e.g., northeast, southeast, southwest, northwest, or headings. Alternatively, direction data may include information about the degrees of rotation relative to a 360 degree compass, such as, e.g., a vehicle facing directly east may correspond to a direction of 90 degrees. The geographic location data may include geolocation data, such as, e.g., latitude and longitude coordinates.

Geolocation data pertaining to the mobile, machine and/or vehicle device may be collected and analyzed to derive valuable information on the presence, dwell times, and movements of human beings. For example, a rate of human beings, such as, e.g., the cars in which they are driving or riding, traversing an area at specific times of day and days of the week can be inferred. In some cases, this information may also be used to plan and adapt highway systems, construction plans, and business plans. Significant reductions in vehicle emissions can be achieved, congestion can be limited, safety can be enhanced, and travel times reduced by helping commuters and other drivers choose uncongested routes to their destinations.

The devices may include a global positioning system (GPS), and may be positioned within a vehicle, such as, e.g., on-board vehicle, to broadcast geographic location data, including telematics sensory data, to one or more other computing devices. The data may be received, processed, and/or analyzed to improve traffic routing, such as, e.g., by synchronizing vehicles and traffic lights, increasing fuel efficiency through reduction of acceleration and deceleration events, determining whether an anomalous condition exists such as a traffic accident, increasing the ability to support mass transit, clearing roads for emergency responders, reducing bottle necks and congestions at popular road segments such as intersections and bridges, monitoring traffic for civic planning such as to determine building new roads or infrastructure, and coordinating construction projects such as to avoid rush hours. These computing devices may be external, such as, e.g., a remote server, another mobile device, and/or a smart traffic infrastructure device, such as, e.g., a smart traffic light, configured to execute one or more algorithms, programs, and/or applications. Big data analysis may be presented in a report, used to generate an alert, and/or create one or more routes for machines or vehicles, and/or mobile devices. For example, an administrator may configure the collections of hundreds or thousands of data samples from numerous devices through a given roadway or intersection over a period of time in order to determine traffic patterns at the location.

### BRIEF DESCRIPTION OF THE DRAWINGS

Figures are illustrated by way of example and are not limited to the accompanying drawings, in which, like references indicate similar elements.

FIG. 1 is a schematic diagram of a vehicular telemetry environment and network infrastructure.

FIG. 2 is a diagram of geolocation data pertaining to a GPS device transmission.

FIG. 3 is a schematic diagram of a protocol translation system.

FIG. 4 is a block diagram of an example protocol translation server.

FIG. 5 is a schematic diagram of an example data architecture.

FIG. 6 is a schematic diagram of a telematics environment comprising a plurality of data providers.

FIG. 7 is a block diagram of protocol mapping.

FIG. 8 is block diagram of an exemplary visual representation protocol mapping.

FIG. 9 is a flow diagram of a method for normalizing and standardizing a data transaction from a source to a destination.

FIG. 10 is a flow diagram of a method for decrypting, encrypting, normalizing, and standardizing a data transaction from a source to a destination.

FIG. 11 is a flow diagram of a method for normalizing and standardizing network packets of a data transaction.

FIG. 12 is a flow diagram of a method for processing telematics data associated with multiple vehicles or machines.

FIG. 13 is a flow diagram of a method for standardizing a vehicle or machine operation data.

FIG. 14 is a schematic diagram of a telematics device attached to, or embedded with, a mobile device, machine asset or vehicle.

FIG. 15 is a schematic illustration of a central server.

FIG. 16 illustrates a computing environment of a mobile device.

FIG. 17 is a flowchart of an example fleet operation method.

FIG. 18 shows a vehicle traversing a route comprising a plurality of geolocation data points to reach a point-of-interest (POI).

FIG. 19 is an example table of a geolocation data log.

FIG. 20 is a schematic diagram of components that may be used to build a database of past routes.

FIG. 21 is a flowchart of a method for building a database of past routes.

FIG. 22 is an example format of a route record stored in a database.

FIGS. 23A-B are diagrams of geolocation clusters associated with a plurality of devices.

FIG. 24 is a flow diagram of a method for determining or verifying travel mode, route, and/or traffic flow at a destination.

FIG. 25 is a schematic diagram of a map comprising GPS data on a two-way street.

FIG. 26 is a schematic diagram of a map comprising GPS data on a one-way street.

FIG. 27 is a schematic diagram of a map comprising GPS data on a turn-restricted path.

FIG. 28 is a schematic diagram of a map comprising GPS data with the presence of a stop signal.

FIGS. 29A-B are flow diagrams for a method of visualizing GPS data.

FIG. 30 is a sample map on which routes may be traveled.

FIG. 31 is a flowchart of a method for creating a new route through a plurality of known routes.

FIG. 32 is a flowchart of a method for comparing a past route with an alternative route.

FIG. 33 is an example report produced from route and vehicle databases.

### DETAILED DESCRIPTION

Although the present has been described with reference to specific examples, it will be evident that various modifications and changes may be made without departing from their spirit and scope. The modifications and variations include any relevant combination of the disclosed features. Equivalent elements, materials, processes or steps may be substituted for those representatively illustrated and described herein. Certain structures and features may be utilized independently of the use of other structures and features. In addition, the components shown in the figures, their connections, couplings, relationships, and their functions, are meant to be exemplary only, and are not meant to limit the examples described herein.

Telematics data, including geographic location data, may be collected, monitored, measured, and/or generated by one or more processors communicatively coupled with memory and associated with a mobile, machine, and/or vehicle device. Telematics data may also be collected from one or more external vendors. The telematics data may include various metrics that indicate the direction, speed, and/or motion of the device in which the data is associated. Direction may be relative to points on a fixed compass, such as cardinal points, e.g., north, south, east and west, or intermediate directions, e.g., northeast, southeast, southwest, northwest, or headings. Alternatively, direction data may include information about the degrees of rotation relative to a 360 degree compass, such as, e.g., a vehicle facing directly east may correspond to a direction of 90 degrees. The geographic location data may include geolocation data, such as, e.g., latitude and longitude coordinates.

Geolocation data pertaining to the mobile, machine and/or vehicle device may be collected and analyzed to derive valuable information on the presence, dwell times, and movements of human beings. For example, a rate of human beings, such as, e.g., the cars in which they are driving or riding, traversing an area at specific times of day and days of the week can be inferred. In some cases, this information may also be used to plan and adapt highway systems, construction plans, and business plans. Significant reductions in vehicle emissions can be achieved, congestion can be limited, safety can be enhanced, and travel times reduced by helping commuters and other drivers choose uncongested routes to their destinations.

The devices may include a global positioning system (GPS), and may be positioned within a vehicle, such as, e.g., on-board vehicle, to broadcast geographic location data, including telematics sensory data, to one or more other computing devices. The data may be received, processed, and/or analyzed to improve traffic routing, such as, e.g., by synchronizing vehicles and traffic lights, increasing fuel efficiency through reduction of acceleration and deceleration events, determining whether an anomalous condition exists such as a traffic accident, increasing the ability to support mass transit, clearing roads for emergency responders, reducing bottle necks and congestions at popular road segments such as intersections and bridges, monitoring traffic for civic planning such as to determine building new roads or infrastructure, and coordinating construction projects such as to avoid rush hours. These computing devices may be external, such as, e.g., a remote server, another mobile device, and/or a smart traffic infrastructure device, such as, e.g., a smart traffic light, configured to execute one or more algorithms, programs, and/or applications. Big data analysis may be presented in a report, used to generate an alert, and/or create one or more routes for machines or vehicles, and/or mobile devices.

Telematics is a compound word of “telecommunication” and “informatics”. A telematics system may include one or more vehicles connected to the vehicle management system for providing a service through a wireless communication. A telematics system and platform can be used to bi-directionally communicate between a centralized system and a vehicle, or a vehicle and another vehicle on the same or different platforms. Telematics systems can be used to transmit data about any sort of task, event or activity that has occurred or that needs to occur in the future, e.g. a work assignment. Dispatchers in centralized and de-centralized locations can track, consume, and analyze data originating from the vehicle's onboard or aftermarket telematics transmission unit in real-time or variations of real-time, based on cellular and mobile network restrictions. Data captured from the vehicle, the vehicle onboard computer, or the vehicle's operating system may be retransmitted to other systems, databases, or platforms. In addition to collecting data about the location, speed, altitude, engine diagnostics, and etc., the telematics system may also record information on diverse events that may be aggregated and to analyze historical traffic patterns, or predict future traffic behavior by including the tracked data into a real-time traffic-enabled routing engine. Accordingly, a driver may actively cope with the diverse events. Traditionally, this relates to transporting and receiving data establishing methods between the telematics and the vehicle management system for defining a wireless data protocol. A system discussing telematics data and route optimization has been described in U.S. patent application Ser. No. 15/456,521, entitled, “Complex dynamic route sequencing for multi-vehicle fleets using traffic and real-world constraints”, with a filing date on Mar. 11, 2017 (now U.S. Pat. No. 9,792,575, issued on Oct. 17, 2017), and which is incorporated herein by reference in its entirety for all purposes.

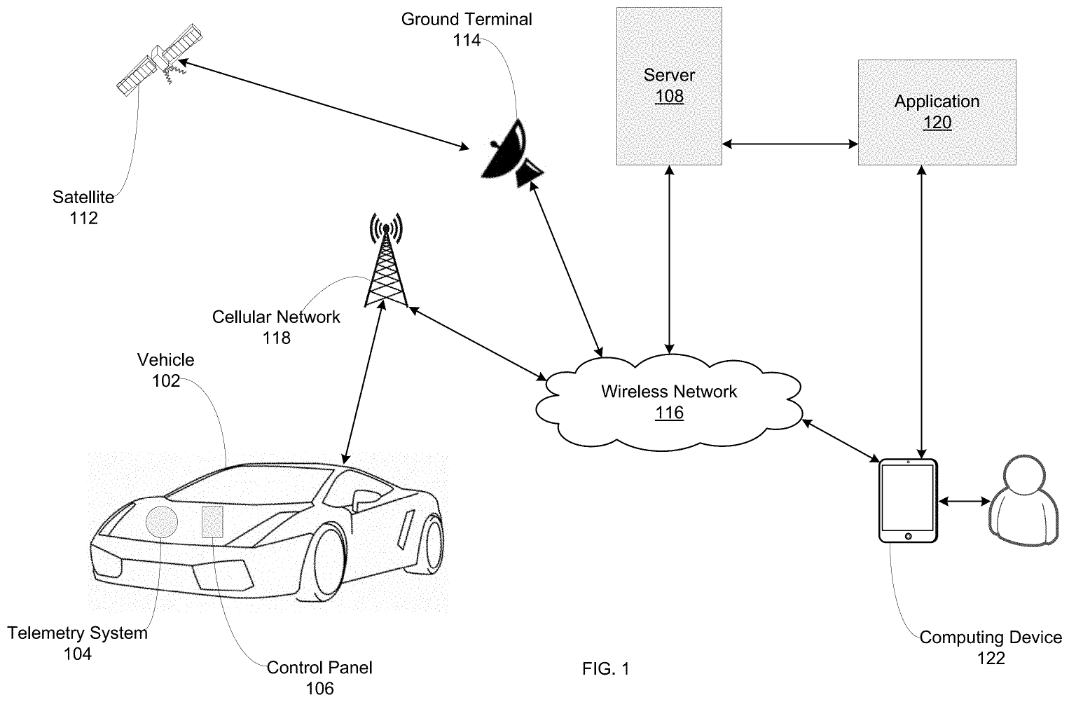

FIG. 1 is a schematic diagram of a vehicular telemetry environment and network infrastructure. A machine or vehicle 102 may include telemetry system 104, which may comprise a telemetry processor, a wireless communications processor, a GPS device, an accelerometer, a non-volatile memory, and a provision for an on-board diagnostic (OBD) interface for communication with a vehicle control panel 106. Although the vehicle is shown as a car, by way of example, it could be of any type, such as, e.g., a bus, truck, motorcycle, bicycle, aircraft, maritime vessel, or even a pedestrian. The control panel 106 may comprise a network communications system and bus, an electronic control module (ECM), a power train control module (PCM), an electronic control unit (ECU), and other engine control/monitor computers and microcontrollers. There may be a Bluetooth module (not shown) for communication with the telemetry hardware system 104.

The telemetry system 104 may monitor and log raw telematics data, such as, e.g., vehicle data such as vehicle identification number (VIN), odometer reading, current speed, heading direction, engine RPM, battery voltage, engine temperature, coolant level, accelerator and brake pedal positions, transmission data, mass air flow and fuel data, tire pressure, oil levels, and emission control data; GPS coordinates data; accelerometer data such as magnitude and direction of acceleration, orientation data and vibration and shock data, traffic data; near-field communication (NFC) data such as driver identification and verification; vehicle sensor data such as engine ignition, engine speed, vehicle speed, vehicle location, status of vehicle seat belts engagement, doors, handles, distance traveled, throttle position, brake pedal position, parking brake position, temperature, cargo hold utilization, moisture, pressure, distance, time, amount and type of inventory, weight data, driver distraction data, remote worker data, school bus warning lights, doors and windows open/closed data; and data concerning an object associated with a Bluetooth beacon such as object acceleration data, object temperature data, battery level data, object pressure data, object luminance data and user defined object sensor data. These objects may include, but are not limited to, packages, equipment, drivers and support personnel; and, object data may be used to indicate damage to an article or a hazardous condition to an article. The different categories of data are illustrative and may further include other data.

A category of raw telematics data may be a grouping or classification of a type of similar or related data, and may include a complete set or a subset of the raw telematics data. For example, GPS coordinates data may be a group or type of similar data; accelerometer data may be another group or type of similar data. A log may include any combination of data categories. A person skilled in the art may recognize that the makeup, format and variety of each log of raw telematics data in each category is complex and may be significantly different from another category. The amount of data in each category may also be significantly different, and the frequency and timing for communicating the data may vary greatly. The monitoring, logging and communicating of multiple logs of raw telematics data may result in the creation of raw telematics big data. For example, the data can be used for auditing, insertion into a blockchain, real-time financial analysis, cost analysis, estimated labor costs, real-time fraud analysis, a data backend for machine learning applications, and etc.

The vehicular telemetry environment and infrastructure may provide communication and exchange of raw telematics data, commands, and messages between one or more server 108, computing device 122 such as, e.g., a desktop computer, mobile device, or wearable device, and vehicle 102. Satellite 112 may provide bi-directional communication with ground terminal 114 through a radio frequency (RF) signal and/or an optical signal. The ground terminal may be communicatively coupled with wireless network 116. Computing device 122, server 108, and telemetry system 104 of vehicle 102 may communicate over wireless network 116 through corresponding software application 120. Cellular network 118 may also be communicatively coupled to wireless network 116. Data and information may be sent from telemetry system 104 to control panel 106, to cellular network 118, to wireless network 116, and then to server 108. Computing device 122 may be able to access the data and information on server 108. Alternatively, data and information may be sent from server 108 to wireless network 116, to cellular network 118, and then to telemetry system 104.

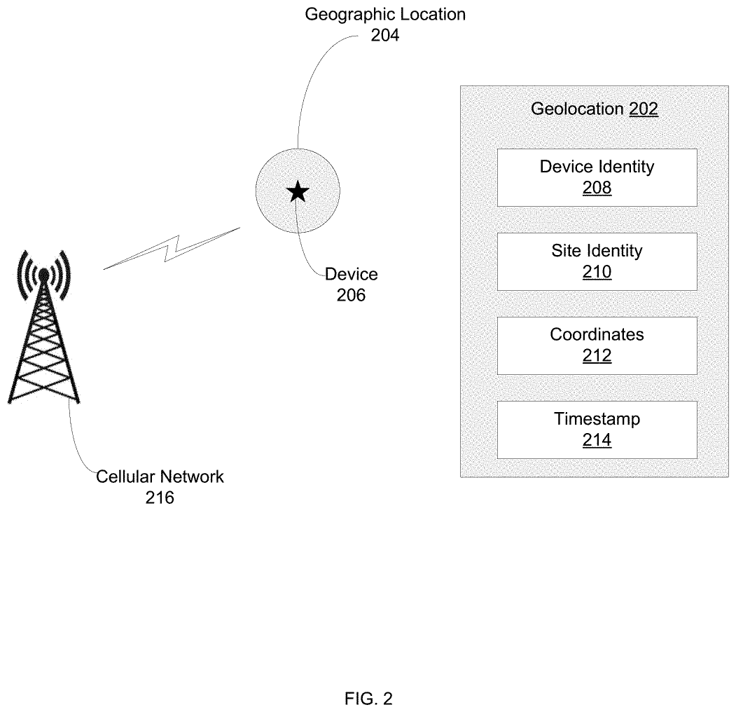

FIG. 2 is a diagram of geolocation data pertaining to a GPS device transmission.

Geolocation 202 may be a data structure for storing information about a geographic location 204 associated with GPS device 206. Device 206 may be a mobile, machine, or an on-board vehicle device that is communicatively coupled to cellular network 216, such as, e.g., through a wireless link. Geolocation data may also be collected from one or more external vendors. Geolocation 202 may comprise information about the geographic location 204 of device 206 captured at a point in time, which may comprise a device identity 208, a site identity 210, coordinates 212, and a timestamp 214 comprising a date and time of data capture. The coordinates 212 of geolocation 202 may be stored as a latitude-longitude value pair, or as a different format, such as, e.g., a geohash. Site identity 210 may be directed to a cellular network 216's identification, and may be null or blank if geolocation 202 was captured when device 206 was out of electromagnetic coverage, such as, e.g. if device 206 captures and stores geolocation 202 when out of cellular network 216's coverage and then uploads the information at a later time when it is again in coverage.

A system and a method for an autonomous bi-directional integration of telematics platforms, e.g., different APIs, through protocol transforming, standardizing, and/or integrating of machine telematics data and/or Internet-of-Things (IoT) data. The platform permits seamless merging of disparate telematics and IoT resources into a single interface, removing the need to connect to propriety systems individually, and allowing an administrator to concurrently track and manage hundreds of millions of vehicles in a centralized system. Through the process of integrating and standardizing telematics and IoT resources, a custom universal data format may be defined. Machines, vehicles, and IoT devices may establish communications and data links through the platform, in which each machine, vehicle, and/or IoT device shares, or fuses, sensor data. For example, a vehicle may share data, e.g., location, speed, event, with any connected system or with another vehicle around the corner that an accident has occurred in the vicinity. The platform also permits vehicles and machines to use their onboard sensors to detect ambient environment risk levels and objects through sensors, surrounding vehicles, and machines that would normally be non-detectable due to range, physical obstruction, lack of other telemetry device, and etc.

An example of a sensor positioned along roadways that may provide traffic data input to a vehicle, that would be transmitted to the platform is a loop sensor that may be capable of measuring the number of vehicles passing above the sensor per unit time, vehicle speed and/or other traffic flow data. The sensors may also include cameras, motion sensors, radar ranging devices, RFID devices, and other types of sensors positioned near or embedded within a road. Another example is a digital message sign on or near route segments to inform drivers about upcoming road conditions, such as, e.g., road maintenance and road closure. In addition to the message being displayed, other traffic data that may be transmitted includes: the conditions that caused the message to display, the estimated length of any traffic restrictions in effect, the name of the road that the segment is a part of, and the location of the segment, such as, e.g., state, city, and/or geographical coordinates. Electronic message information may be provided by the Department of Transportation (DOT) of the respective state in which the road is located. Each state may maintain its own historical database comprising past displayed messages that may be accessible through the network.

An example of a sensor positioned in vehicles that are operated by the user includes a positioning circuitry configured to determine a geographic position of a mobile device. The circuitry may include sensing devices that measure the mobile device's travel data, e.g., traveling distance, speed, engine temperature, oil temperature, status of locks and airbags, direction, vehicle manufacturer, and vehicle specification. Detectors and/or sensors within the positioning circuitry may include an accelerometer and/or a magnetic sensor embedded within the mobile device. The accelerometer may be operable to detect, recognize, and/or measure the rate of change of translational and/or rotational movement. The magnetic sensor, e.g., a compass, may be configured to generate data indicative of a heading. Data from the accelerometer and the magnetic sensor may indicate orientation of the mobile device, and thus the vehicle. Another example is an on-board diagnostic sensor sensing vehicle attributes, such as carbon dioxide emissions. Carbon dioxide emission may be detected by the sensor or it may be computed by the miles-per-gallon (MPG) value of the vehicle assigned to the route, obtained from the vehicle manufacturer. A route optimization server may re-sequence the destinations of one or more routes when carbon dioxide emissions data surpasses a predetermined threshold. For example, if the system determines that carbon dioxide emissions level surpasses the acceptable threshold level for a certain route that is caused by extreme increases in elevation, e.g., hills, then the optimization server may re-sequence the destinations of the route to avoid such road segments. Through optimizing routes for carbon dioxide emissions, the platform may be able to reduce vehicle stress, lower fuel consumption, and reduce travel time and/or distance.

A transmission system in the mobile device may communicate with the platform and optimization server through a network, such as, e.g., a cellular communication network. The platform may be a software- and web-based program implemented in a processor of a remote computing device that is also coupled with the network. For example, each user may transmit information about its current position through a position detection device coupled with an antenna, such as, e.g., a GPS system. The mobile device may comprise other internal and/or external sensors, such as, e.g., a motion sensor, a microphone, a camera, a biometric sensor, an accelerometer, a gyroscope, and/or a magnetometer, and may identify drivers and/or user behaviors based on sensory data. If the mobile device generates large amounts of high-resolution data, the platform may optimally receive all of or part of the generated data through simplification and/or compression algorithms, and etc. In addition to user or driver behaviors, the sensory data may allow the system to reveal customer behaviors, such as, e.g., a customer who is chronically not home, that may be factored into the route optimization. A transmission may also include other information linked to the vehicle's current position, such as, e.g., a comparison of the change in coordinates with respect to time, which may be used by the platform to develop information about how a user is maneuvering through traffic and to determine existing traffic conditions, such as, e.g., traffic speed.

In order to function properly, a series of intermediary functions, applications, programs, and transformation rules, including data pivoting and unpivoting, which may be stored in a database and executed by a processor, and specify how to universally transform ingress and egress data. A protocol may be defined as a structured communication pattern comprising sets of rules shared by two or more communicating parties to facilitate data exchange. These rules can have two parts: syntax and semantic. Syntax refers to the format of the messages that are to be exchanged, while semantic refers to the sequence of operations to be performed by each party when events occur, such as, e.g., timeouts and reception of messages.

The platform of the present invention may require a number of servers configured for protocol translation including logic, e.g., firmware or middleware, to receive a number of network packets associated with a particular transaction from a source delivery server. The logic may analyze data received to synchronously determine a data format and a protocol of the received network packets, and may apply a number of rule-based protocols. The rule-based protocols may reformat, e.g., transform, the data format and the protocol of the received network packets according to a data format and a protocol of a destination server, relay the reformatted data or network packets to the destination server, and provide a response to the source delivery server. The data may be normalized prior to the transmission to the destination server and may be optionally stored in a STEM (Security Information Events Management) system. The response may include a status confirmation of the previous transaction. The system and the method may enable the translation server to automatically search, detect, and connect to known devices, such as a known source delivery server, e.g., a telematics data provider, or a known destination server, e.g., a machine, vehicle, or IoT device. For example, when a machine, vehicle, and/or IoT device wish to establish a communication session with the protocol translation servers, a handshake procedure may be carried out using a cryptographically secure protocol, such as, e.g., Secure Sockets Layer (SSL). The automatic authentication handshake permits a device to self-provision onto the platform by verifying that the device is part of a pre-approved list eligible for syndication. The handshake procedure may comprise determining whether each party has certain required attributes, such as, e.g., a name, location, owner, or role, to exchange cryptographic data for enabling shared keys for establishing the communication session.

The system and the method may allow for transforming, standardizing, and/or integrating of telematics protocol for a plurality of machines or machine manufacturers, including receiving telematics data from multiple telematics data providers in communication with the machines, determining whether the telematics data from each of the telematics data providers is in a standard format, and transforming the telematics data to the standard format if the data is in a non-standard format. The transformed data may be used for data replication, data synchronization, real-time or batch backups, and data mirroring. Transformed data may be inserted directly, or through an intermediary telematics service, into any other compatible telematics system. A graphical user interface (GUI) may display the telematics data in the standard format to an administrator.

Since a vehicle fleet may include vehicles having different makes, models, and or model years having different operation reporting capabilities, the data available from the data providers can be different for some vehicles of the vehicle fleet than for other vehicles. Telematics data from the telematics data providers may be in non-standard formats, such as, e.g., Association of Equipment Management Professionals (AEMP) standard, or any other data standards. Each of the telematics data providers may include a web-based application programming interface (API) for accessing the associated telematics data in the corresponding formats. Telematics data providers typically use proprietary data communication protocols. These various protocols are not interchangeable, and to the contrary, they only enable communication among a particular manufacturer, or group, of machines. Telematics and IoT data providers may include, but are not limited to, a datacenter or data warehouse that stores telematics data of the associated machines, an onboard telematics system associated with the machines, and/or a third-party provider.

For example, if a vehicle fleet includes both light-duty vehicles, such as, e.g., commuter vehicles, and heavy-duty vehicles, such as, e.g., semi-trailers, the light-duty and heavy-duty vehicles may report different operation measurements usable for understanding the operation of the vehicles. The heavy-duty vehicles and one group of the light-duty vehicles may, for instance, maintain an odometer measurement readable by a telemetry system. On the other hand, another group of light-duty vehicles in the vehicle fleet may not be capable of outputting odometer measurements readable by same telemetry system. Instead, drivers of the vehicles may be expected to manually read the odometer measurements and provide the measurements with corresponding timestamps for input to the platform. In another example, a vehicle fleet may include different makes and model years of vehicles having different fuel measurement reporting capabilities. One group of makes and years of vehicles in the fleet may provide measurements of lifetime usage of fuel that are readable by the telemetry system. On the other hand, another group having different makes and years of vehicles may provide running measurements of fuel used per time that may also be readable by the telemetry system. The different fuel measurements from the groups can be provided to the platform so that uniform fleet vehicle fuel consumption information can be determined for the trucks and provided to a user of the vehicle platform.

The meaning of measurements related to vehicles in a fleet may further depend on the make, model, type, and/or year of the vehicles, such as, e.g., a low fuel indication from a vehicle or machine may correspond to a certain percentage of remaining fuel in the fuel tank, for example, 20% fuel remaining, and may differ from the low fuel indication from another vehicle or machine which corresponds to a higher percentage of fuel remaining in the fuel tank, for example, 25% fuel remaining. In addition, measurements available from a motorcycle may have a different meaning from the measurements available from a car, truck, crane, fork lift, or another vehicle type.

The type and capabilities of the telemetry system may also influence the available measurements from vehicles that are provided to the platform. For example, some vehicle telemetry systems may be capable of communicating with an engine computer to obtain a measurement of engine revolutions per minute (RPM), recording video from a dashcam or other sensors, and etc. Other vehicle telemetry systems may not be capable of communicating with the engine computer, or other sensor data, and thus may rely on one or more other measurements usable to determine the RPM measurement for the vehicle. In another example, some vehicle telemetry systems may be equipped with GPS features that enable telemetry system to calculate a distance traveled by the vehicles. The calculation may provide measurements comparable to the odometer readings of the vehicles. In yet another example, some telemetry systems may be capable of determining fuel economy by directly obtaining measurements by the vehicles. On the other hand, other vehicle telemetry systems may be capable of using measurements of an amount of fuel consumed and distance traveled to calculate fuel economy.

The platform may either operate in a default autonomous mode whereby processes are fully automated from end-to-end without user intervention including having the ability to autonomously authorize complete cycles, or it may operate in a user-guided semi-autonomous mode. The user-guided semi-autonomous mode may be used to, e.g., override certain processes or procedures, check for availability of assets, maintain visual inspection, and/or troubleshoot machines and operations. The user may interact through a graphical user interface, such as, e.g., a virtual or augmented reality environment, or through a voice-activated personal assistant. Similar to a human body's autonomous nervous system unconsciously controlling vital organs and biological functions while responding to stimuli, the autonomous system and method of the present invention may respond and adapt to dynamic demands in real-time. The system may provide automated functions that may accelerate or decelerate the logistics supply pipeline by either speeding up or slowing down the various operations within downstream processes and their corresponding modules, while eliminating or automating many of the labor-intensive and time-consuming operations required in legacy systems. A graphical user interface may be communicatively coupled to the server and may provide interactive control to one or more users of the network. A simulator may be used to help user management make strategic decisions. The simulator may mimic different aspects, such as, e.g., demands, supplies, inventories, manufactures and transportation, before an operation is actually conducted. The user may view the predicted outcome of a given operation and may adjust parameters to further improve the performances or to avoid complications.

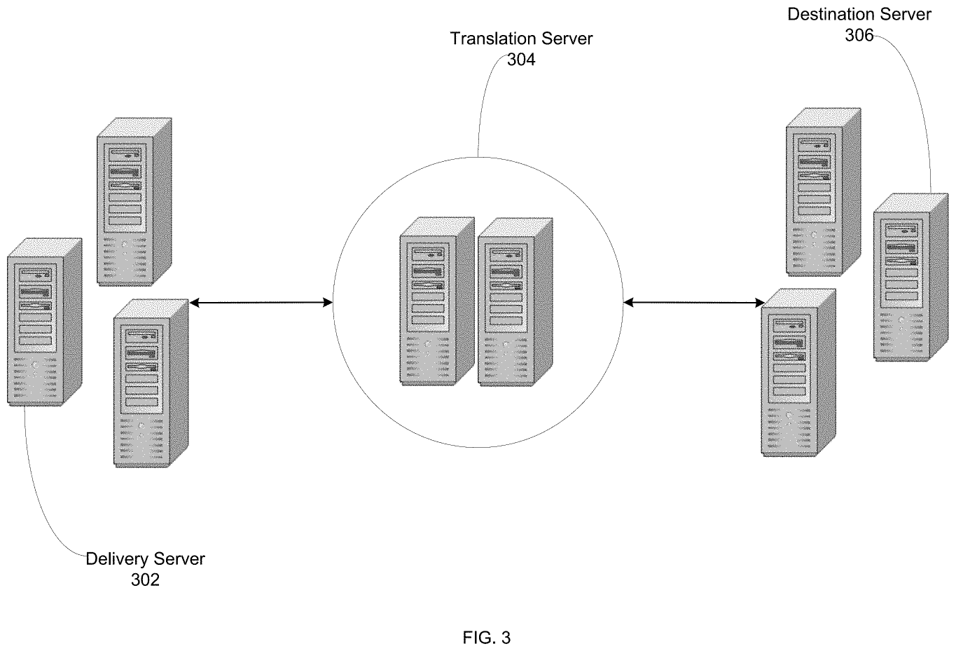

FIG. 3 is a schematic diagram of a protocol translation system. The system may include one or more source delivery server 302 comprising a plurality of data formats and protocols, such as, e.g., simple mail transfer protocol (SMTP), hypertext transfer protocol (HTTP), Quick UDP Internet Connections (QUIC), and/or a cloud computing source protocol. Source delivery server 302 may be communicatively coupled to one or more protocol translation server 304, such as, e.g., through a wireless network, for rule-based protocol translation between source delivery server 302 and one or more destination server 306. Destination server 306 may also comprise a plurality of data formats and protocols, such as, e.g., simple mail transfer protocol (SMTP), hypertext transfer protocol (HTTP), and/or a cloud computing source protocol, and may differ from that of source delivery server 302. Destination server 306 may also be communicatively coupled with translation server 304.

Protocol translation server 304 may include logic that can receive a number of network packets associated with a particular transaction from source delivery server 302 to destination server 306 to facilitate subsequent application of rule-based protocols. Based on data of the network packets associated with a particular transaction, a rule-based protocol may be based on a criteria specified by a user or administrator, and may comprise embedded rules, limitations, data maps and routes, and/or characteristics of destination server 306 such as, e.g., a specification of destination server 306, data and format of network packets associated with a particular transaction, and presence of communication restrictions. The logic may determine a data format and protocol of the received network packets, and reformat it according to that of destination server 306 prior to relaying the packets to destination server 306. For example, a number of rule-based protocols based on an SMTP source delivery server 302 may relay data to a destination server 306 of varied protocols, such as, e.g., SMTP and HTTP. In such an example, protocol translation server 304 may be an SMTP-translator, capable of reformatting data and protocol of SMTP transactions to relay the SMTP network packets to destination server 306. Although three delivery server 302s and three destination server 306s are illustrated, more or fewer of each may be included.

For example, protocol translation server 304 may standardize disparate measurements obtained by a telemetry system into a uniform set of information related to a vehicle or machine fleet for storage or presentation to a user of the platform, such as, e.g., estimating diagnostic or status information, using one or more varying measurements from other vehicles or machines in the fleet. The standardized information can enable the user of the platform to receive meaningful vehicle operation information in a uniform form while relieving the user of the burden of considering more than a single source. The standardized measurements may be readily compared to other measurements for the mobile device, vehicle or machine, or across diverse vehicle or machine types, makes, models, and/or model year.

Protocol translation server 304 may estimate information for multiple vehicles or machines, such as, e.g., determining the odometer readings indicative of a distance traveled for one group in a fleet based on odometer measurements provided by the telemetry systems of another group. The platform may also determine a distance traveled by one group in a fleet based on GPS measurements of vehicles and machines in another group, such as, e.g., by extrapolating the data, calculating a line-distance traveled by the vehicles or machines within the fleet, and/or automatically preparing data in a big data compatible format to enable operating expense audits, capital expense audits, and generating financial models to determine fleet savings. Protocol translation server 304 may switch between two or more sources as available measurements change or select between, or prioritize, the measurements based on a quality value, such as, e.g., accuracy or reliability of the data. Protocol translation server 304 may group vehicles or machines having one or more similar criteria or measurements to assist in the standardization of disparate measurements for vehicles or machines using one or more rule sets corresponding to the group.

Other examples of ways that the protocol translation server 304 may standardize disparate measurements are next described, such as, e.g., total time engine on, hydraulic status and revolutions per minute (RPM). A user may desire to determine the total number of hours that engines of vehicles or machines of a fleet are turned on. The engine computers of some vehicles or machines of the fleet may directly measure the total number of hours the engines are on, and these measurements may be obtained by protocol translation server 304. However, for some vehicles or machines in the fleet, the only indication of engine on-time is a binary status of whether the engines are turned on or off. Protocol translation server 304 may, for these vehicles, calculate the total engine-on time based on the duration of the binary status that indicates the engines are turned on.

A user may desire to determine the hydraulic status of vehicles or machines in a fleet. Some vehicles or machines in the fleet may directly measure their hydraulics and provide operational status to their telemetry systems. Other vehicles or machines in the fleet, however, may provide the hydraulic status based on a calculation using the hydraulic pressure level. Protocol translation server 304 may, for these vehicles or machines, determine that the hydraulic is on when pressure is greater than zero.

A user may desire to determine the RPMs of engines of vehicles or machines in a fleet. The RPM measurements, however, may be provided differently according to makes, models and/or model year. The platform may access information regarding how the different makes, models, and years report measurements so that protocol translation server 304 may standardize the estimated RPM information into a common form.

Because the accuracy or precision of measurements may vary significantly depending on, e.g., the source, timing, frequency, estimated accuracy, and/or sophistication of the measurements, the measurements obtained by the platform may be associated with one or more indications of quality, such as, e.g., assigning a value score. The indications of quality of the measurements may be utilized by the platform to manage or process the measurements, such as, e.g. protocol translation server 304 may request or discard certain measurements related to particular vehicles or machines in a fleet based on the one or more indications of quality. Timestamps may also be assigned to the measurements and/or determined estimates of information by the platform, and may be used to track frequency of the determinations, as well as in determining or assigning quality indications to the determinations. For example, a recently determined estimate may correspond to a higher quality score than a less recently determined estimate.

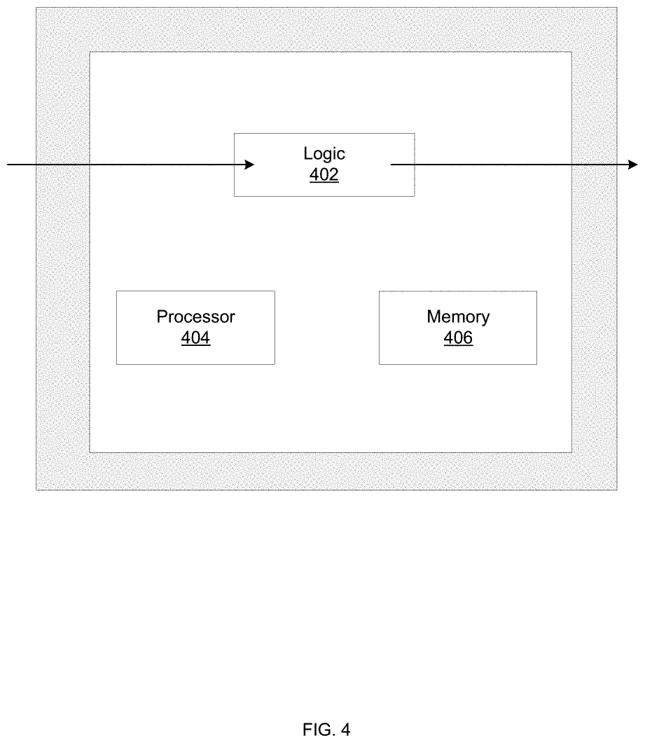

FIG. 4 is a block diagram of an example protocol translation server. The server may include logic 402 communicatively coupled with processor 404, which in-turn may be communicatively coupled with memory 406. As used herein, “logic” may imply hardware, such as, e.g., various forms of transistor logic and application specific integrated circuits (ASICs), as opposed to computer executable instructions, such as, e.g., software and firmware. For example, rule-based protocols and applications may be stored on a non-transitory computer readable memory (CRM) associated with the protocol translation server and may be downloadable by local memory 406 and executable by processor 404. The CRM may include volatile and/or non-volatile memory, and may be communicatively coupled to a computing device. Volatile memory may be memory that depends upon power to store information, such as, e.g., various types of dynamic random access memory (DRAM). Non-volatile memory may be memory that does not depend upon power to store information, such as, e.g., solid state media such as flash memory, EEPROM, phase change random access memory (PCRAM), magnetic memory such as a hard disk, tape drives, floppy disk, tape memory, optical discs, digital video discs (DVD), high definition digital versatile discs (HD DVD), compact discs (CD), solid state drive (SSD), flash memory, as well as other types of machine-readable media. The CRM may comprise computer-readable instructions stored thereon that may be executed by processor 404 to provide a particular functionality.

The CRM may be internally coupled to processor 404 via a communication path, such as, e.g., an electronic bus wherein the CRM is one of volatile, non-volatile, fixed, and/or removable storage medium. Examples of an electronic bus may include, e.g., Industry Standard Architecture (ISA), Peripheral Component Interconnect (PCI), Advanced Technology Attachment (ATA), and Small Computer System Interface (SCSI), Universal Serial Bus (USB). The communication path may be remote such that the CRM is coupled to processor 404, through wire or wire-less, via a network connection, such as, e.g., a local area network (LAN), a wide area network (WAN), a personal area network (PAN), and the Internet. As such, the CRM may be associated with a first computing device, such as, e.g., a server, and processor 404 may be associated with a second computing device, such as, e.g., a client. Local memory 406 of the protocol translation server may be configured for protocol translation that can store the rule-based protocols and executable by processor 404.

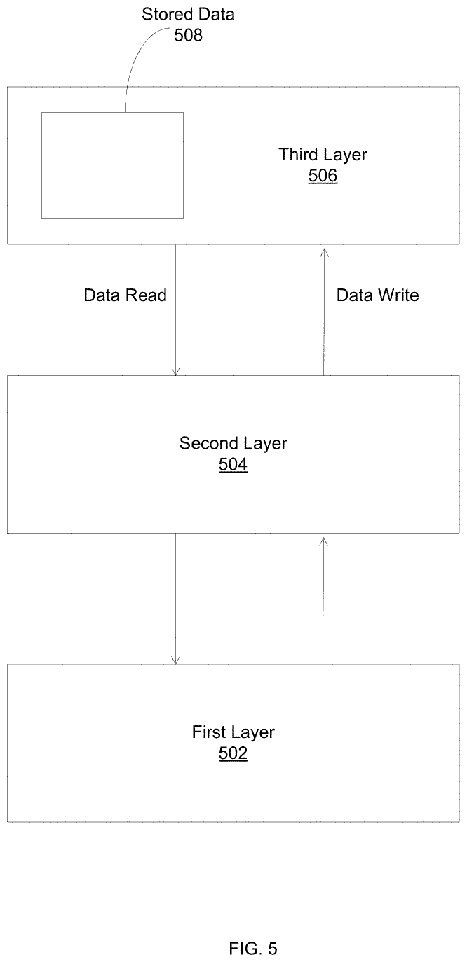

FIG. 5 is a schematic diagram of an example data architecture. First layer 502 may make a request for services, such as, e.g., that data be written and/or read. Second layer 504 may receive the request and may then fulfill it, assuming, for example, that it is able to do so. There are a variety of services that may be provided by second layer 504. Primarily, such services are data-related, such as, e.g., authentication, authorization, data storage and/or retrieval. Second layer 504 may supplement and/or enhance services that may be available from third layer 506. One service that may be provided by second layer 504 includes security. For example, this may include firewall functionality, such as, e.g. packet filtering, inspection, and/or format validation, and data encryption and/or decryption. Encryption may include a process in which data is coded so that the content of the data is not capable of being employed and/or understood by a person and/or a device without first being decoded back to the previous form or format it had prior to being encrypted. Decryption may be a process of decoding encrypted data back to the form or format it had prior to encryption. The data, once encrypted, may be stored by or at third layer 506 at stored data 508. Likewise, second layer 504 may, upon another request for services by first layer 502, such as, e.g., a read request, retrieve the stored, encrypted data from third layer 506, decrypt it, and provide it to first layer 504.

Any two layers, such as, e.g., first layer 502 and third layer 506, may reside on the same computing platform, or on multiple computing devices. Third layer 506 may treat data substantially the same regardless of whether or not the data is encrypted. This may provide some benefits, such as, e.g., making interoperability with other systems possible. Encryption may be applied only to a payload portion of the transferred data, making encryption transparent to the storage device.

Further, data may be encrypted using a first encryption protocol by first layer 502 and transferred to second layer 504 using a first data transfer protocol. Data may be decrypted and translated from the first data transfer protocol to a second data transfer protocol at second layer 504. Translation may refer to reformatting data from a format that may be compatible with one data transfer protocol to a format that may be compatible with a different data transfer protocol. Data may also be re-encrypted at second layer 504 using a second encryption protocol and delivered to third layer 506 using a second data transfer protocol. A particular data safeguarding strategy and/or data transfer protocol may be used for transferring data from first layer 502 to second layer 504 and another data safeguarding strategy and/or data transfer protocol may be used for delivering data to and storing data at third layer 506. Data transfer among the layers may not be encrypted, or only encrypted between specific layers.

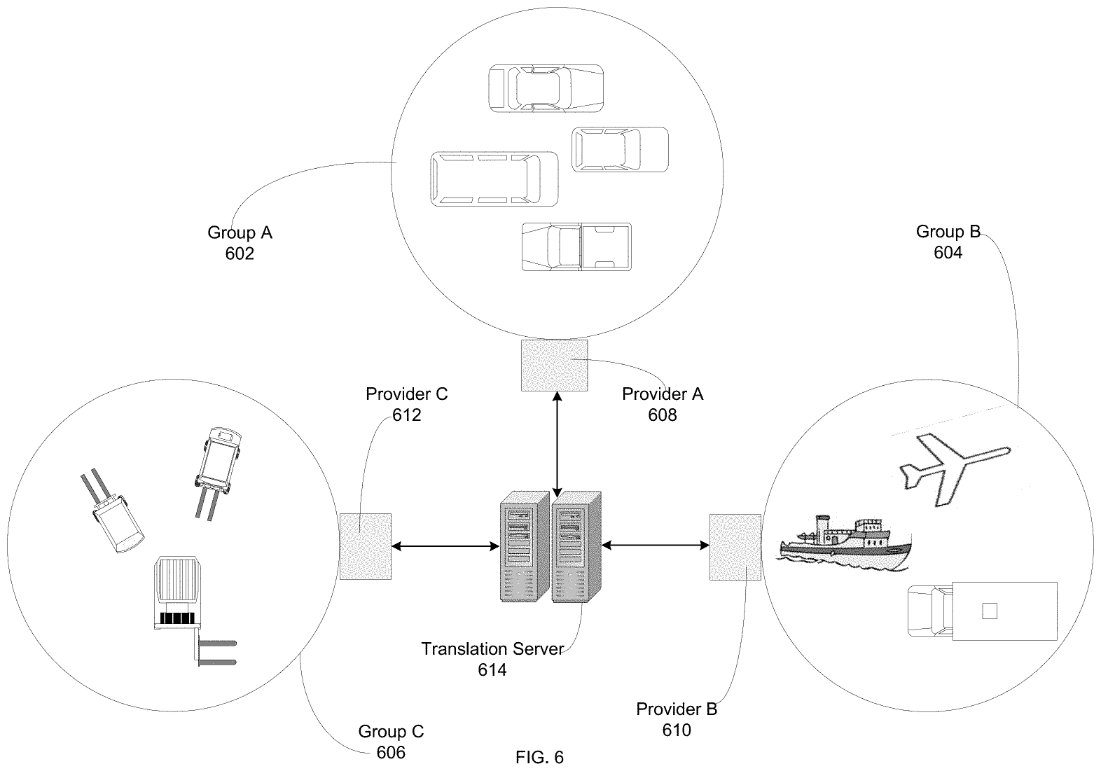

FIG. 6 is a schematic diagram of a telematics environment comprising a plurality of data providers. The environment may include group A 602, group B 604, and group C 606, which may comprise one or more various types of machines and vehicles. The machines and vehicles may be organized based on a similarity criterion, such as, e.g., manufacturer and/or functionality, and may include manned, fully autonomous and/or semi-autonomous machines and vehicles. For example, group A 602 may be personnel transportation machines and vehicles, such as, e.g., passenger cars; group B 604 may be warehouse or worksite machines and vehicles, such as, e.g., forklifts, pallet trucks, and mining trucks; and group C 606 may be long distance machines and vehicles, such as, e.g., aircrafts, trucks, watercrafts, and freight trains.

The environment may include telematics data provider A 608, provider B 610, and provider C 612, which may be in communication with the machines and vehicles of group A 602, group B 604, and group C 606. Telematics data provider A 608, provider B 610, and provider C 612 may be configured to monitor or read telematics data associated with the respective machines and vehicles, such as, e.g., over a network. The network may be, but not limited to, a wide area network (WAN), a local area network (LAN), an Ethernet, an Internet, an Intranet, a cellular network, a satellite network, or any other suitable network for transmitting data between the machines and vehicles and the telematics data provider. The network may include a combination of two or more of the aforementioned networks and/or other types of networks known in the art, and may be implemented as a wired network, a wireless network or a combination thereof. Data transmission may take place over the network with a network protocol such that the data transmission is in an encrypted format, or any other secure format. Telematics data provider A 608, provider B 610, and provider C 612 may be configured to relay the telematics data retrieved from the machines and vehicles of group A 602, group B 604, and group C 606 to protocol translation server 614, which in turn may be communicatively coupled to one or more destination servers, as previously discussed.

To accomplish transforming, standardizing and/or integrating telematics and/or IoT data, signal mapping from one protocol to another protocol may be employed. For example, a first protocol is received by the platform, and a mapping interface is generated to a second protocol. The first protocol may then be mapped to the second protocol in accordance with the mapping interface, and the second protocol may become the first protocol of a downstream transformation relationship. The mapping interface may comprise a visual representation, such as, e.g., a relational database, graph database, key/value, NoSQL database, diagram, chart, and/or table, of the relationship between the first protocol and the first format, and the second protocol and the second format. The opposite may be true wherein the second protocol may be mapped to the first protocol and data is transformed from the second protocol to the first protocol according to the mapping interface. For example, the visual representation may comprise links between the measurements and the standardized information. The links may include one or more indications of the approaches or techniques used to standardize the disparate measurements and pointers associating the measurements and standardized information.

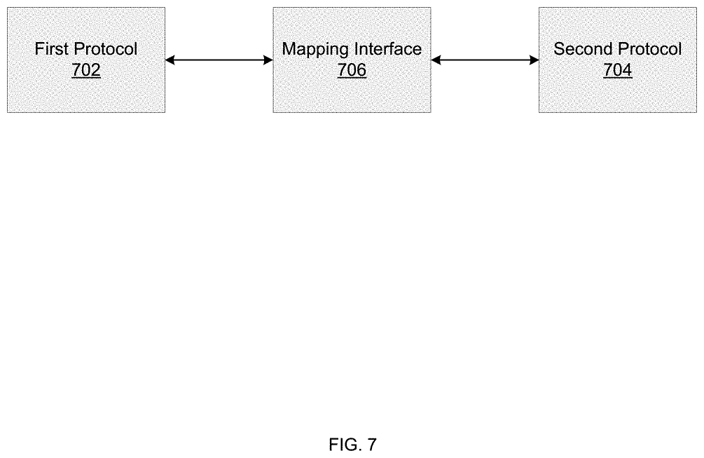

FIG. 7 is a block diagram of protocol mapping. A first protocol 702, such as, e.g., for vehicle telematics data and/or IoT data from a data provider, may be mapped to a second protocol 704, such as, e.g., to normalizing and standardizing with the platform of the present invention and thus, with vehicle telematics data and/or IoT data from another data provider. A mapping interface 706 may be generated and may comprise a visual representation, such as, e.g., a relational database, diagram, chart, and/or table, of the relationship between the first protocol and the first format and the second protocol and the second format. For each transformation from first protocol 702 to second protocol 704—or vice versa—various designation information may be stored in a mapping definition information area and data is transferred in accordance with the designation or mapping information.

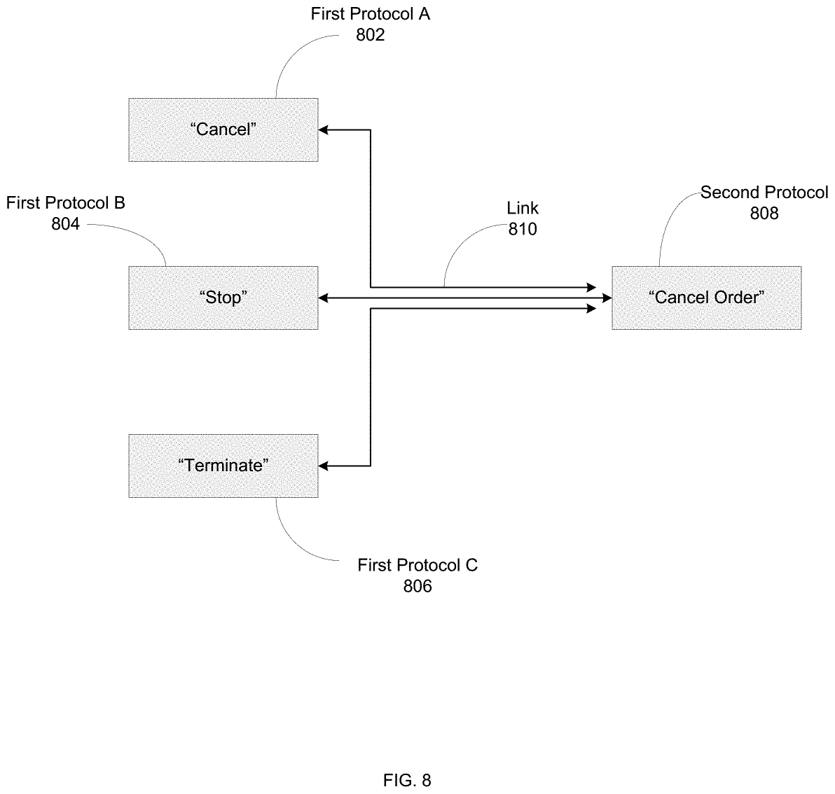

FIG. 8 is block diagram of an exemplary visual representation protocol mapping. First protocol A 802, first protocol B 804, first protocol C 806 may represent three separate telematics data or IoT data providers, and may comprise the data “cancel”, “stop”, and “terminate”, respectively. The data may be transformed, standardized and integrated to be understood as “cancel order” in second protocol 808, as shown by link 810. A telematics or IoT data provider may include, but not limited to, a datacenter or data warehouse that stores telematics data of the associated machines, an onboard telematics system associated with the machines, and/or a third-party provider.

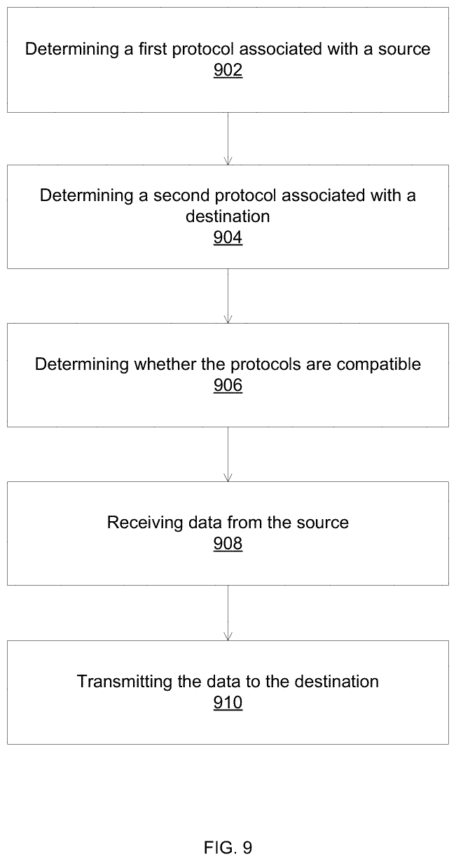

FIG. 9 is a flow diagram of a method for normalizing and standardizing a data transaction from a source to a destination. Operation 902 determines a first protocol associated with a source, such as, e.g., a telematics data provider, server, on-board sensor, and/or external sensor. Operation 904 determines a second protocol associated with a destination, such as, e.g., a telemetry system of a vehicle or machine and/or a user interface of the platform of the present invention. Operation 906 determines whether the first protocol from the source and the second protocol from the destination are compatible, such as, e.g., in the same format. Operation 908 receives data from the source. The data may be in a form based on the first protocol. Operation 910 transmits the data to the destination. The data may be in the form based on the second protocol. The determination of operation 906 regulates whether the data being sent from the source to the destination is converted to the second protocol, such as, e.g., if the data are not compatible, then the platform may normalize and standardize the data by converting the first protocol to the second protocol according to a mapping interface. The data may be normalized and standardized based on a third, custom protocol that is determined by an administrator of the platform.

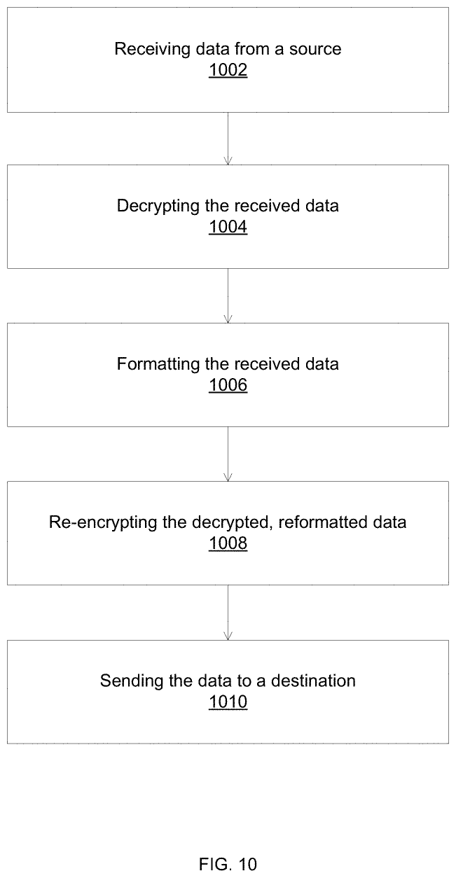

FIG. 10 is a flow diagram of a method for decrypting, encrypting, normalizing, and standardizing a data transaction from a source to a destination. Operation 1002 receives data from a source, such as, e.g., a telematics data provider, server, on-board sensor, and/or external sensor. The data may be in a form based on the first protocol. The data may be encrypted according to a first encryption protocol. In other embodiments, the data may not be encrypted. Operation 1004 decrypts the received data. Operation 1006 reformats the received, decrypted data based on a second data transfer protocol, and according to a mapping interface. In some embodiments, the data may not be reformatted. Operation 1008 re-encrypts the decrypted, reformatted data according to a second encryption protocol. In some cases, the data is not re-encrypted. Operation 1010 sends the re-encrypted, reformatted data to a destination, such as, e.g., a telemetry system of a vehicle or machine and/or a user interface of the platform based on a second data transfer protocol.

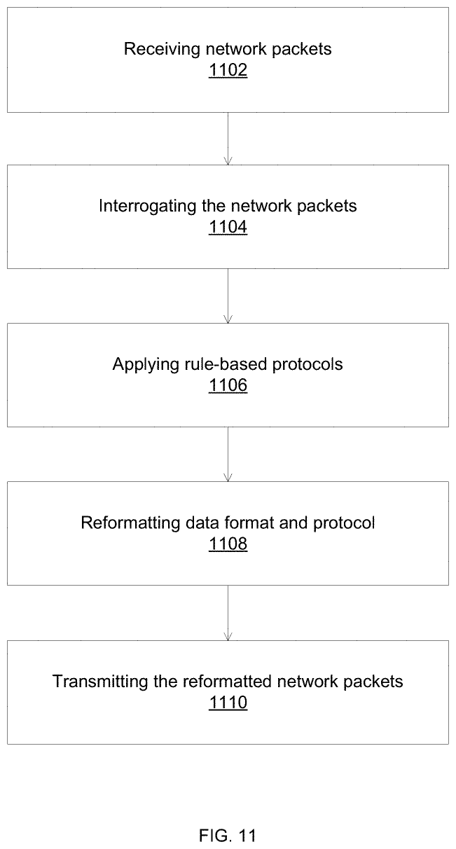

FIG. 11 is a flow diagram of a method for normalizing and standardizing network packets of a data transaction. Operation 1102 receives a number of network packets associated with a particular transaction from one or more sources, such as, e.g., a telematics data provider, server, on-board sensor, and/or external sensor. Operation 1104 interrogates the number of network packets received, which may include identifying criteria and embedded rules, limitations, and characteristics of the, such as, e.g., to determine the data format of the header and message. Operation 1106 applies a number of rule-based protocols based on the results operation 1104. Operation 1108 reformats a data format and a protocol of the received network packets so that the network packets are acceptable to one or more destinations, such as, e.g., a telemetry system of a vehicle or machine and/or a user interface of the platform of the present invention. Reformatting, for example, may include recomposing the header and message to comply with the data format and protocol of the destination. Operation 1110 transmits the reformatted network packets to the one or more destinations.

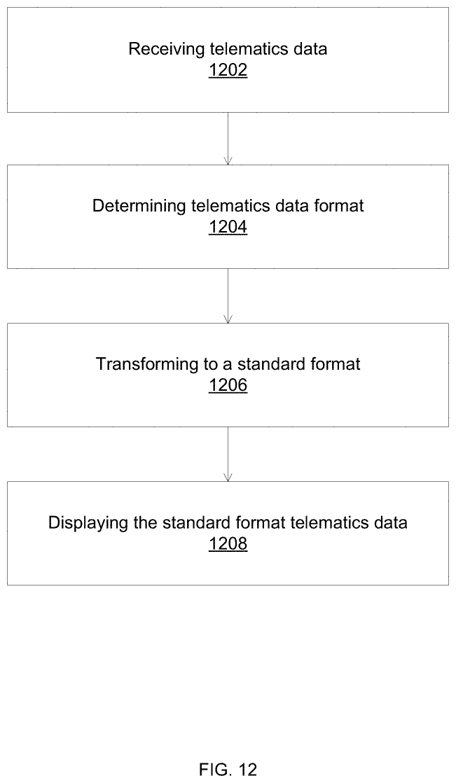

FIG. 12 is a flow diagram of a method for processing telematics data associated with multiple vehicles or machines. Operation 1202 receives telematics data from a plurality of data providers after retrieving authentication information for accessing the data that are in communication with a plurality of vehicles or machines. The telematics data providers may include different applications of manufacturing companies, third-party telematics data providers, on-board telematics systems, and etc. Operation 1204 determines the format of the received data. The data from each of the telematics data providers may be in a non-standard format, such as, e.g., AEMP standard or non-AEMP standards, and/or a standard format, such as, e.g., a custom format proprietary to the platform of the present invention. Operation 1206 transforms the telematics data in the non-standard format to the standard format according to a mapping interface. In some cases, the telematics data may already be in the standard format, e.g., an API may be configured to accept the telematics data in the standard format from the corresponding telematics data providers. Multiple telematics data providers may be prioritized based on a level of confidence, such as, e.g., company reputation and/or quality measurement. Telematics data from the telematics data providers may include a unique identifier associated with the corresponding vehicle or machine. Operation 1208 displays the telematics data in standard format via a graphical user interface (GUI).

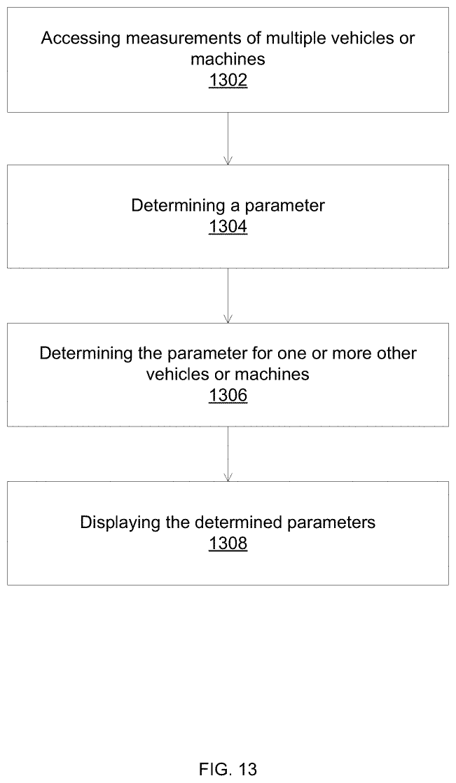

FIG. 13 is a flow diagram of a method for standardizing a vehicle or machine operation data. Operation 1302 accesses measurements related to multiple vehicles or machines in a fleet, such as, e.g., location or speed. Operation 1304 determines a parameter for one or more vehicles or machines in the fleet using one or more measurements. For example, a distance traveled for a vehicle may be estimated using odometer measurements from the engine computer of the vehicle. Operation 1306 determines the same parameter for one or more vehicles or machines, such as, e.g., a distance traveled for a particular vehicle may be estimated using GPS position data of the other vehicles in the fleet. Operation 1308 displays the determined parameters, such as, e.g., through a GUI.

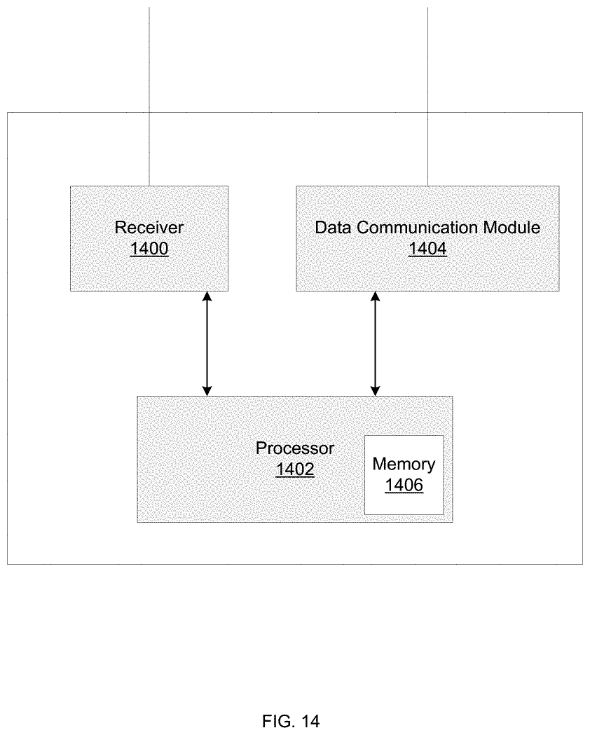

FIG. 14 is a schematic diagram of a telematics device attached to, or embedded with, a mobile device, machine asset or vehicle. The telematics device may comprise a receiver 1400, a processor 1402, a communication module 1404, and a memory 1406. The receiver 1400 is operable to determine location information of a vehicle or mobile device using satellite network data. Typically, this data comprises coordinates, speed, and direction of the telematics device. The processor 1402 may receive location information from the receiver 1400 and transmit to a central server using the data communication module 1404 at predetermined time intervals. The communication module 1404 is preferably a cellular transmitter operable to send data from the telematics device over a cellular network, or alternatively, over a satellite network or wireless network connection. The data communication module 1404 may comprise a receiver to receive information and data from the central server. The telematics device may be configured to control a variety of vehicle sensors, such as, e.g., capture and store vehicle telematics data generated by the sensors for analyzing. In some situations, the telematics data may be unable to be immediately transmitted, such as, e.g., due to unavailability of Internet connectivity. In such cases, the system may temporarily store, such as, e.g., accumulate or queue, data to its local computer storage and retransmit data as soon as stable Internet connectivity is re-established. The accumulated data may then get removed from memory 1406 after successful transmission to the central system server.

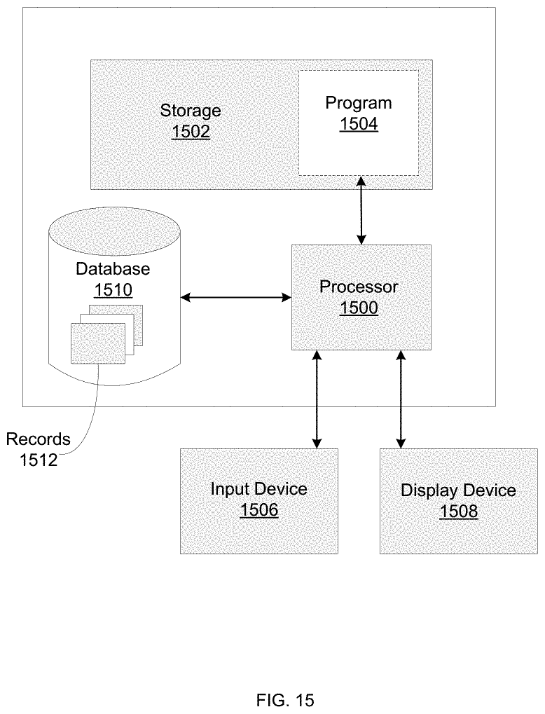

FIG. 15 is a schematic illustration of a central server. The central server may be a conventional computer operable to execute coded instructions comprising a processor 1500, a memory storage device 1502, a program 1504, an input device 1506, and a display device 1508. The processor 1500 may be any processing unit that is typically known in the art with the capacity to run computer program 1504, and may be communicatively coupled to memory storage 1502, such as, e.g., a local hard-disk. Input device 1506 may be any device suitable for inputting data into the central server, such as, e.g., a keyboard and a mouse, and may be communicatively coupled to processor 1500. Display device 1508 may be any suitable device communicatively coupled to processor 1500 operable for displaying data to a user or administrator of the system. Program 1504 may be stored in memory storage 1502, and may be operable to provide instructions to processor 1500. Database 1510 may be communicatively coupled to the central server and operable to store data. Typically, database 1510 comprises a number of records 1512 corresponding with transit operations, such as, e.g., a delivery job, an initial pick-up location, a driver identifier, a vehicle position, and a time stamp.

In some cases, in addition to receiving telematics data from vehicle sensors, a mobile device may be configured to collect and transmit telematics data on its own. For example, the mobile device may include a location determining device, such as a GPS, for providing location information of the driver, as opposed to location information associated with the vehicle or vessel.

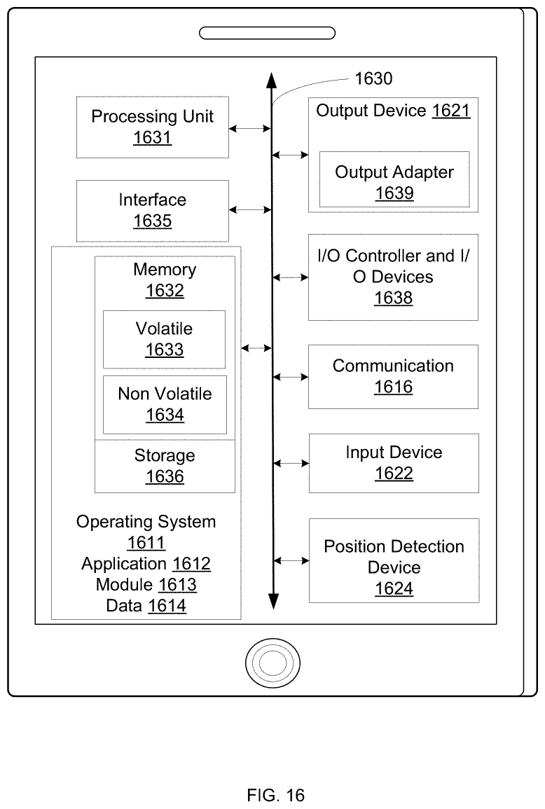

FIG. 16 illustrates a computing environment of a mobile device. The processing unit 1631 may be any of various available processors, such as single microprocessor, dual microprocessors or other multiprocessor architectures. The system bus 1630 may be any type of bus structures or architectures, such as 12-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), or Small Computer Systems Interface (SCST).

The system memory 1632 may include volatile memory 1633 and nonvolatile memory 1634. Nonvolatile memory 1634 may include read only memory (ROM), programmable ROM (PROM), electrically programmable ROM (EPROM), electrically erasable ROM (EEPROM), or flash memory. Volatile memory 1633, may include random access memory (RAM), synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), or direct Rambus RAM (DRRAM).

The mobile device also includes storage media 1636, such as removable/non-removable, volatile/nonvolatile disk storage, magnetic disk drive, floppy disk drive, tape drive, Jaz drive, Zip drive, LS-100 drive, flash memory card, memory stick, optical disk drive such as a compact disk ROM device (CD-ROM), CD recordable drive (CD-R Drive), CD rewritable drive (CD-RW Drive) or a digital versatile disk ROM drive (DVD-ROM). A removable or non-removable interface 1635 may be used to facilitate connection.

The mobile device may further include software to operate in the computing environment, such as an operating system 1611, system applications 1612, program modules 1613 and program data 1614, which are stored either in system memory 1632 or on disk storage 1636. Various operating systems or combinations of operating systems may be used.

Input device 1622 may be used to enter commands or data, and may include a pointing device such as a mouse, trackball, stylus, touch pad, keyboard, microphone, joystick, game pad, satellite dish, scanner, TV tuner card, sound card, digital camera, digital video camera, web camera, and the like, connected through interface ports 1638. Interface ports 1638 may include a serial port, a parallel port, a game port, a universal serial bus (USB), and a 1394 bus. The interface ports 1638 may also accommodate output devices 1621. For example, a USB port may be used to provide input to the mobile device and to output information from the mobile device to an output device 1621. Output adapter 1639, such as video or sound cards, is provided to connect to some output devices such as monitors, speakers, and printers.

The position detection device 1624 may be a device that communicates with a plurality of positioning satellites, e.g., GPS satellites, to determine the geographical location of the mobile device, and thus the user. To determine the location of the user, the position detection device 1624 searches for and collects GPS information or signals from four or more GPS satellites that are in view of the position detection device 1624. Using the determined time interval between the broadcast time and reception time of each signal, the position detection device 1624 may calculate the distance of the user relative to each of the four or more GPS satellites. These distance measurements, along with the position and time information received in the signals, allow the position detection device 1624 to calculate the geographical location of the user.

The mobile device may be communicatively coupled to remote computers, such as, e.g., the platform, through the network. The remote computers may comprise a memory storage device, and may be a personal computer, a server, a router, a network PC, a workstation, a microprocessor-based appliance, a peer device or other common network node and the like. Remote computers may be connected to the mobile device through a network interface and communication connection 1616, with wire or wireless connections. A network interface may be communication networks such as local-area networks (LAN), wide area networks (WAN) or wireless connection networks, or by cellular network communication technology. LAN technologies include Fiber Distributed Data Interface (FDDI), Copper Distributed Data Interface (CDDI), Ethernet/IEEE 1202.3, Token Ring/IEEE 1202.5 and the like. WAN technologies include, but are not limited to, point-to-point links, circuit switching networks like Integrated Services Digital Networks (ISDN) and variations thereon, packet switching networks, and Digital Subscriber Lines (DSL).

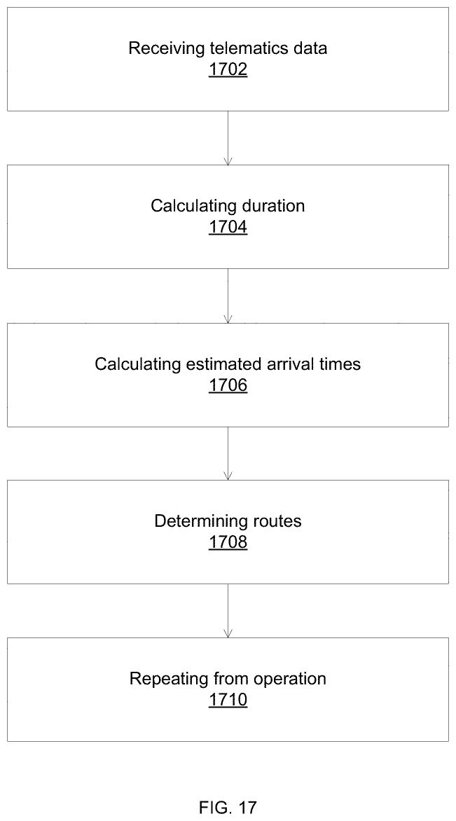

FIG. 17 is a flowchart of an example fleet operation method. The method may be repeated indefinitely until the fleet operation, such as, e.g., a delivery job, is complete. Operation 1702 receives telematics data such as coordinates of a fleet operation's asset, e.g., trucks, trains, ships, aircrafts, watercrafts, micro-drones, delivery drones, humanoid robots, self-driving or self-guided car robot drones. Location information may comprise, e.g., an asset or device identification, cellular network identification coordinates, timestamp data, direction, and speed. Operation 1704 calculates duration for each assigned destination of the fleet operation. A job that is in progress may comprise an estimated remaining time to completion, and a job that has not begun may comprise an estimated total time required to complete. Duration, for example, may typically be the time to unload or deliver an inventory at a destination, and/or load the asset for transporting to a next destination. Operation 1706 calculates estimated arrival times of all pending destinations. For example, a delivery job that is currently in progress will comprise an estimated arrival time of zero. Operation 1708 determines routes for all assets to fulfill all remaining destinations. Assets may be assigned destinations or jobs based on estimated duration from operation 1704 such that multiple assets arrive at the destination or job when the previous asset's duration reaches zero. Typically, there will be more destinations or jobs than assets such that when an asset finishes with a destination or job, it may be dispatched to another destination or job. When an asset has completed a job, it may be assigned another based on the information known about all of the other remaining unassigned or assigned jobs being completed by the other assets, such as, e.g., duration, remaining route, completed route, asset compatibility, operational constraints, environment constraints, geographic constraints and/or inventory compatibility. Operation 1710 repeats operations 1702 to 1710.

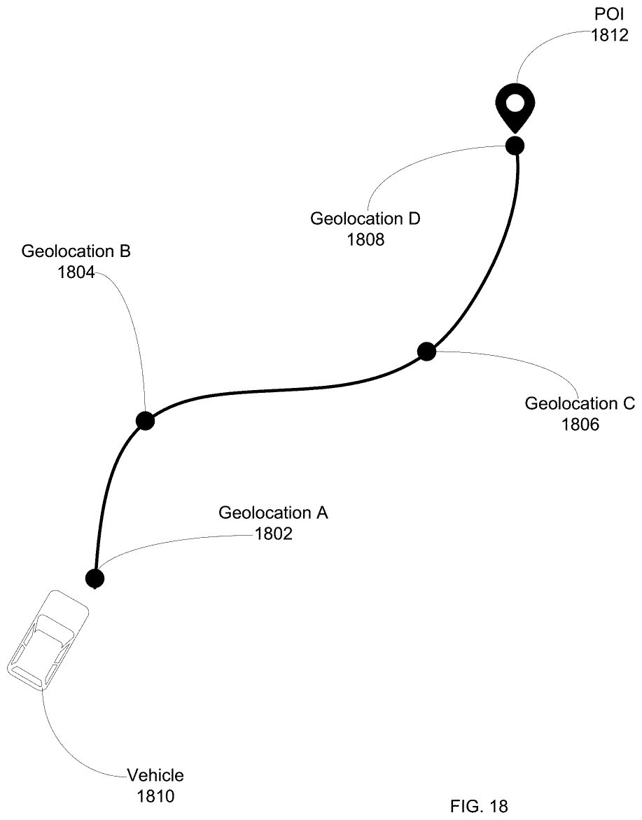

FIG. 18 shows a vehicle traversing a route comprising a plurality of geolocation data points to reach a point-of-interest (POI). The route may comprise a plurality of geolocations, e.g., geolocation A 1802, geolocation B 1804, geolocation C 1806, and geolocation D 1808 associated with vehicle 1810. The geolocations, or geolocation data points, may comprise an identity of a device, such as, e.g., a mobile, a machine, an on-board vehicle device, an identity of a cellular network that the device is communicatively coupled with when the data is created, a location coordinates data, and a timestamp comprising a date and a time of the creation. Vehicle 1810 may travel the route from geolocation A 1802 to geolocation B 1804, then to geolocation C 1806, then to geolocation D 1808, then to reach POI 1812. POI 1812 may be a destination of the route, such as, e.g., a delivery job destination, an event venue, a business location, a dining area, a home, or any other location. Although POI 1812 alludes to a “point”, it may be extended in two or three dimensions, such as, e.g. a billboard or a walking trail. Geolocation A 1802 may comprise an earlier timestamp than geolocation B 1804; geolocation B 1804 may comprise an earlier timestamp than geolocation C 1806; and geolocation C 1806 may comprise an earlier timestamp than geolocation D 1808.

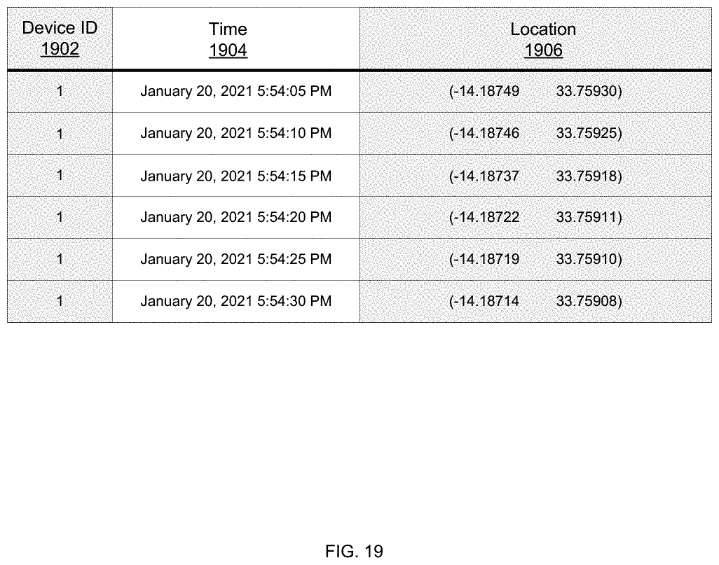

FIG. 19 is an example table of a geolocation data log. The table may comprise columns device ID 1902, time 1904, and location 1906. Device ID 1902 may correspond with the identification with the mobile, machine, or vehicle device with which the log is associated. In some cases, a user identification of the device may be used in addition to, or alternatively to device ID 1902. Time 1904 may be the recorded date and time that the entry was created from the device. In this example, an entry was created at a predetermined time interval of 5 seconds. Location 1906 may be the coordinates, such as, e.g., latitude and longitude, of the device's location. In some cases, altitude may also be logged as a third coordinate. Additional columns and information may be added.

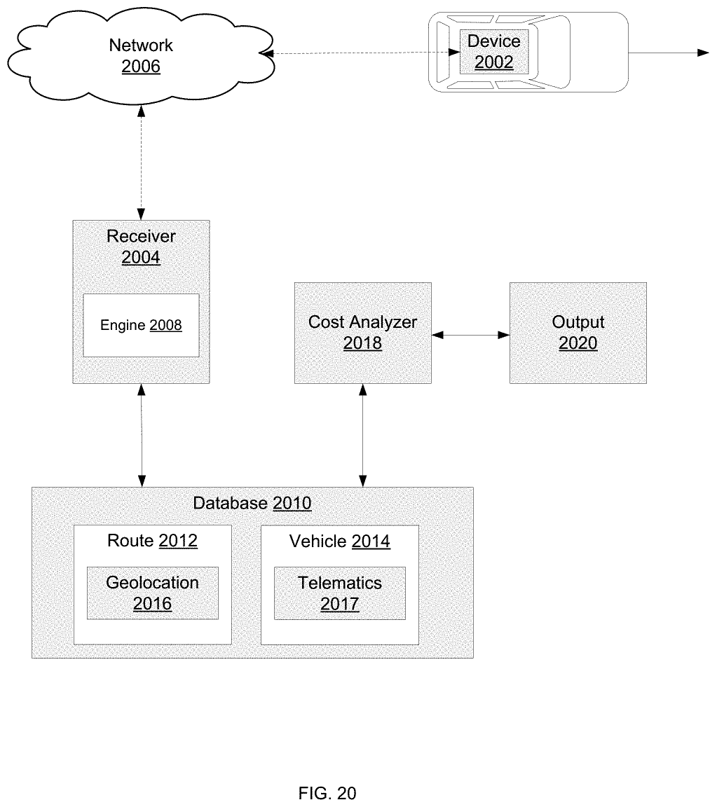

FIG. 20 is a schematic diagram of components that may be used to build a database of past routes. Route data may be built by any mechanism, such as, e.g., a person has actually been observed to travel along the route, a digitally calculated route, or it may be a stored route. For example, travelers may opt-in to having their device continually determine their location and to have this information collected by a service. Since the information collected represents actual routes, it provides continual verification of, e.g., turns that appear on a map which can be made in real life, duration to travel the routes, how travel time and availability of turns correlates with the time of day and the number of people in a vehicle, and other factors. In addition, this can provide a higher level of accuracy for data analysis as compared with purely simulated data. Actual route and vehicle data may account for driver behavior, road obstacles, signage, vegetation, vehicle characteristics, and other factors that may not be able to be captured otherwise. When a database of routes is collected, the database may be used to respond to requests for directions. If the route is stored, it may be retrieved and provided as directions.

Device 2002 may be associated with a vehicle traveling to a destination, and indicated by an arrow. Although the vehicle is shown as a car, by way of example, it could be of any type, such as, e.g., a bus, truck, a motorcycle, a bicycle, an aircraft, a maritime vessel, or even a pedestrian. Device 2002 may be a telematics device, such as, e.g., a mobile, machine, or vehicle device, comprising sensors and configured to determine its current location on the globe and transmit coordinates of that location to external receiver 2004. The collection may be performed through a wireless network 2006, such as, e.g., a cellular network, and may be at a predetermined distance interval, e.g., every 50 meters, or a predetermined time interval, e.g., once per minute. Alternatively, location points may be collected in response to requests sent from a server, such as, e.g., at each destination or stop. A destination or stop can be detected when the device has not changed location for a predetermined amount of time, or by input from the user or driver. External receiver 2004 may provide this information to an engine 2008, which may create database 2010 based on data received from device 2002. Although engine 2008 is shown as an internal component, it may also be external, such as, e.g., a server. Since the data may be raw location data, such, e.g., latitude and longitude coordinates, engine 2008 may apply these coordinates to an actual map to determine the location that was traveled. Once engine 2008 has determined the path that corresponds to the vehicle's travel, it may store it in database 2010.

Database 2010 may comprise data tables, namely, route 2012 and vehicle 2014. Route 2012 may comprise, e.g., the time of day at which the route was traveled, how long it took to travel the route, how many people were in the vehicle at the time the route was traveled, and the type of vehicle was used. Geolocation 2016 may comprise an identity of device 2002, such as, e.g., a mobile, machine, an on-board vehicle device, an identity of a cellular network that device 2002 is communicatively coupled with when the data is created, a location coordinates data, and a timestamp comprising a date and a time of the creation. Through a plurality of GPS data points, coordinates and time data may be used to infer the vehicle's speed of travel, direction heading, and duration of travel. Vehicle 2014 may comprise data related to vehicle information, such as, e.g., VIN, make, model, year, body style, and specification. Vehicle 2014 may also include telematics sensory data 2017. Cost analyzer 2018 may take these factors, and/or other factors, into account to determine cost information for any given route. Cost analyzer 2018 may then transmit this data to output 2020, such as, e.g. a graphical user interface, for displaying the cost data, such as, e.g., in a report, to a user or administrator of device 2002.

Cost data may be based on route 2012, and/or vehicle 2014 including telematics sensory data 2017. Examples of route data 2012 that impact cost include, e.g. duration, distance, speed limit, speed bumps, traffic data, road obstacles, whether roads are paved, schools and/or construction zones, presence of toll booths, traffic lights, signage, and topology such as uphill and/or downhill grades. Generally, longer travel duration and/or distance may be more expensive than shorter travel duration and/or distance. The time associated with making each turn may be taken into account in calculating the overall cost since traveling down a straight road in the absence of traffic is relatively quick, and much of the time spent traveling a route may be spent in the turns. Different costs may be calculated for different times of day the route was taken as the amount of traffic present may vary. The number of passengers in a vehicle at the time the route was traversed may also impact cost of a route because there may be, e.g., lane restrictions and/or toll charges, to which it is dependent from. In some cases, a route complexity score or rating may be assigned based on the foregoing, such as, e.g. a high complexity score is associated with routes that have more turns, changes in orientation, accelerations, decelerations, and changes in speed, and other driving events that are inherently more risky than driving at a single speed along a straight road. For example, a route along a straight highway with little traffic is less complex than a route through the center of a densely trafficked city. The overall score or rating of the alternative route may be on a 0-10 scale, where 0 indicates low complexity and 10 indicates high complexity. Route cost may be directly proportional to its complexity score.

Examples of vehicle data 2014 including telematics sensory data 2017 that impacts cost include, e.g., vehicle specification, vehicle age or condition, and driving behavior. Vehicles that produce more engine power, heavier, and/or older may contribute to cost through fuel usage and maintenance expense. In addition, tall vehicles may have difficult going under certain overpasses; long vehicles may have difficulty making certain turns; and commercial trucks may have to stop at weight stations. Driving behaviors that increases cost includes, e.g., frequent deceleration and acceleration events, which may add to expense due to additional fuel usage and maintenance of the vehicle. Certain behaviors also increases wear-and-tear and cost of vehicle maintenance, such as, e.g., excessive or insufficient speed, rapid deceleration and acceleration events, excessive speed in a curve, acceleration before a curve, over-braking before exiting a curve, and harsh steering maneuvers. Rapid deceleration and acceleration may be classified as an indication of a change in speed that exceeds a predetermined reference threshold over a given time duration. Harsh steering maneuvers may be classified a fast change of direction, or an indication of a number of steering adjustments that exceeds a predetermined reference threshold over a given time duration. Curve over-braking may be classified as an indication of a number of hard and/or long braking instances that exceeds a predetermined reference threshold over a given time duration while the steering angle exceeds a predetermined reference number of degrees. Excessive speed in a curve may be classified as an indication of direction change that is over the acceptable rate corresponding to acceleration.

In some cases, driving behavior and the resulting machine or vehicle operation are monitored and recorded for analysis by the user, administrator, or an automatic algorithm. Periodic recordings of speed and direction of the machine or vehicle while it is being operated are used to calculate acceleration, deceleration and directional change events. Operation data from the recording devices and the calculations performed is then compared to stored reference data to determine is the machine or vehicle was abused or operated in an unsafe manner by the user, and may be outputted to a display. For example, a certain road may have a 65 mph speed limit stored as a reference value, which can be matched with a map. An alert may be generated and displayed when a fleet's machine or vehicle is operated beyond this limit, which may present an over exertion of the asset that may lead to additional maintenance and fuel costs, and/or a dangerous maneuver. In some cases, the reference value or parameter may be specific to the machine or vehicle's capabilities and specification. For example, a low-sitting sports vehicle may have an acceptable reference turning angle that is sharper, e.g., 30-degrees, compared with a large truck, e.g., 40-degrees.

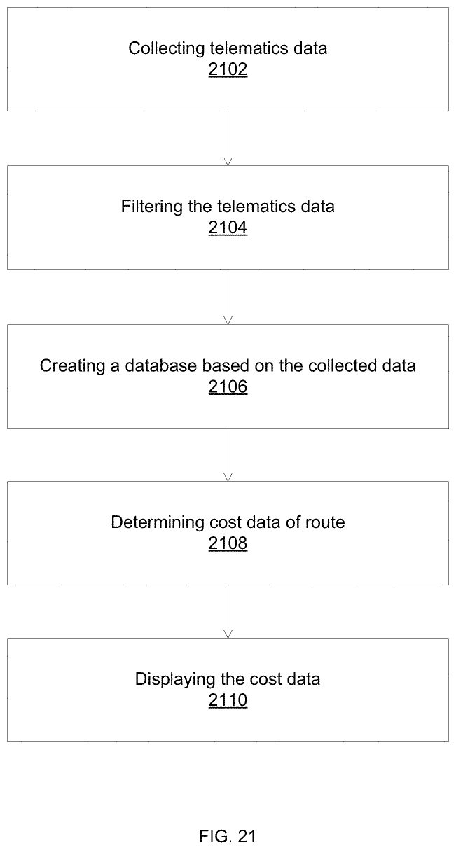

FIG. 21 is a flowchart of a method for building a database of past routes. Operation 2102 collects telematics data including sensory and geolocation data from a mobile, machine, or vehicle device. Telematics data may also be collected from one or more external vendors. Location information may comprise, e.g., an asset or device identification, cellular network identification coordinates, timestamp data, direction, and speed. The collection may be performed through a wireless network, such as, e.g., a cellular network, and may be at a predetermined distance interval, e.g., every 50 meters, or a predetermined time interval, e.g., once per minute. Alternatively, location points may be collected in response to requests sent from a server, such as, e.g., at each destination or stop. A destination or stop can be detected when the device has not changed location for a predetermined amount of time, or by input from the user or driver. The collection of data may be repeated with respect to a large number of devices, e.g., hundreds or thousands, over an extended period of time, such as, e.g., an hour, a day, a week, or a month, depending on the particular application for which the collected information is to be used.

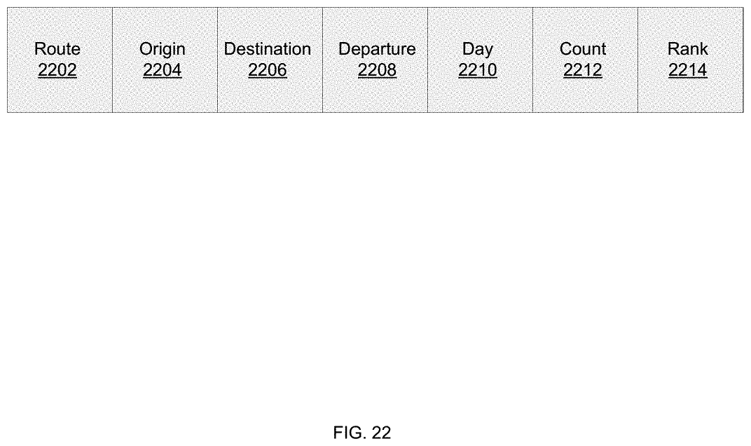

Operation 2104 filters the collected telematics data to remove noisy data based on predefined parameters, such as, e.g., speed, location, direction, road type, vehicle class, timestamp, weather condition, and outliers. As examples, side roads may be filtered out, leaving only highways, or vice versa; a particular type of vehicle may traverse a hilly road more efficiently or an 8-cylinder engine truck may be more efficient in traversing treacherous terrain than a 4-cylinder engine sedan, and may be filtered for; unwanted speed and location may be filtered out; when a commuter travels north, traffic information for eastbound, westbound, and southbound traffic may be filtered out; traffic conditions such as congestion or slow traffic speed may be filtered out; certain weather conditions, such as, e.g., temperature, wind, rain, snow, humidity, and overcast, may be favored over others; less recently determined timestamp may be filtered out as it may not be as reliable or relevant; and outliers may be removed, such as, e.g., if a reported speed is below a certain threshold based on the road type, then the information may be discarded, as it may represent a vehicle prowling for a parking spot, or if the speed is above a certain threshold, then the information may be discarded, as it may represent an aircraft. In addition, speed may be filtered to identify travel mode or route as discussed in FIG. 22.

Operation 2106 creates a database based on the collected data. The database may comprise data tables about the route, such as, e.g., geolocation data, and information about the vehicle traversing the route, such as, e.g., VIN, make, model, year, body style, and specification. Vehicle data may also include telematics sensory data, such as, e.g., acceleration and deceleration events.

Operation 2108 determines cost of the route based on the data tables about the route and vehicle, including sensory data. Examples of route data that impact cost include, e.g. duration, distance, speed limit, speed bumps, traffic data, road obstacles, whether roads are paved, school and/or construction zones, presence of toll booths, grades, traffic lights, signage, and topology such as uphill and/or downhill. In some cases, a route complexity score or rating may be assigned based on the foregoing, such as, e.g. a high complexity score is associated with routes that have more turns, changes in orientation, accelerations, decelerations, changes in speed, and other driving events that are inherently more risky than driving at a single speed along a straight road. For example, a route along a straight highway with little traffic is less complex than a route through the center of a densely trafficked city. The overall score or rating of the alternative route may be on a 0-10 scale, where 0 indicates low complexity and 10 indicates high complexity. Route cost may be directly proportional to its complexity score. Examples of vehicle data including telematics sensory data that impacts cost include, e.g., vehicle specification, vehicle age or condition, and driving behavior. Operation 2110 displays the cost data to a user or administer, such as, e.g., in a report.

FIG. 22 is an example format of a route record stored in a database. The record may comprise route 2202, origin 2204, destination 2206, departure 2208, day 2210, count 2212, and rank 2214. Route 2202 may be a field for storing text or alphanumeric characters identifying the route associated with the record, and may include a driver identifier for associating the route record with a user. Origin 2204 and destination 2206 may be fields for storing location information for the start and end points, respectively. Departure 2208 may be a text field defining or storing the departure time. Day 2210 may indicate the day of the week that the route has been traveled in the past. This field may be useful for identifying routine routes, such as, e.g., to work or school, which occur on particular days of the week, such as, e.g., Monday through Friday. Count 2212 may indicate the total number of times the route has been taken, and may be represented using an exact count, such as, e.g., 1 or 50, or ranges of times, such as, e.g., 1000-2000. Rank 2214 may indicate whether the recorded route information represents a primary, secondary, or tertiary route. These routes may connect the same origin and destination points, with primary routes being more frequently traveled than secondary routes, and secondary routes more frequently traveled than tertiary routes. Rank 2214 may be determined based on the value stored in count 2212, or may be manually set by the user or an administrator. For example, a higher count 2212 may correspond with a higher rank, e.g., primary, and a lower count 2212 may correspond with a lower rank, e.g., secondary or tertiary. Other information may also be provided with the record, such as, e.g., distance, duration, number of passengers, and/or vehicle data.

In some cases, origin 2204 may correspond to multiple routinely traveled routes, such as, e.g., from the user's home. Routine route starting from the user's home could include, e.g., trips to work, school, and the market. A comparison may be made with the current route being taken to a record's departure 2208 corresponding to origin 2204 to determine the matching routine route. In addition, the user or administrator may use the database for a driving profile analysis to suggest possible ways to save time or money. For example, the analysis may determine that if the route is taken a few minutes later, or that if certain routes are combined, overall time and expense spent driving may be achieved.

In general, current computerized mapping systems allow a user or operator to enter a starting point and a destination point. The computerized mapping system may access a map database containing road information. Each road in the database may be broken up into segments. The segments may begin and end at intersections, speed zones, or a change in the number of lanes. The information of a road segment in the map database may include, e.g., the length of the segment, speed limit, and which road segments connect to the endpoints of the segment. The mapping system may plot out a number of probable routes comprised of road segments connecting the starting point and the destination. An estimated travel time for each route may be calculated by summing the quotient of the distance traveled in a particular speed zone by the speed limit of the zone. A route may then be selected based on the shortest estimated time required to travel the route. The travel route may then be communicated to the operator.

Since current vehicle navigation systems use static, rather than dynamic information, changes are not implemented in a timely manner. The updating and distribution of new routes using the currently available methods is not very efficient. The accuracy of this information is very important because of the many very critical scenarios in which auto routing is used. As such static maps are distributed, there is a high probability that some of the routes that have been defined no longer exist because of new roads being created, closed or realigned for various reasons, or because of temporary construction that has caused a major portion of a road to be unusable.

Analysis to determine and/or verify travel modes, routes and/or traffic flows may comprise clustering of geolocation data associated with a plurality of mobile, machine and/or vehicle devices. Geolocation data may also be collected from one or more external vendors. A map may comprise travel modes and/or routes, such as, e.g., a roadway, a railway, aerial travel, marine travel, submarine travel, or a footpath, for reaching one or more destinations. The map may be stored in a first data store, and the geolocation data may be stored in a second data store. Geolocation data may be sorted based on one or more of, e.g., device identity, site identity, coordinates data, and/or a timestamp data and matched to the map to determine travel modes or routes. As examples, a cluster of device identities that matches automobile devices may infer a roadway travel mode or route; a cluster of site identities that matches with a subway station site identity may infer a subway travel mode or route; a cluster of coordinates data matching mountainous terrain may infer a footpath travel mode or route; and a cluster of timestamp data matching a flight schedule may infer an aerial travel mode or route. In addition, travel mode or route may be inferred based on of how the device is carried, such as, e.g., an individual carrying a mobile device while traveling in a vehicle may be distinguished from an individual carrying a mobile device while walking based upon whether the device is plugged into a power source. In general, a travel mode may refer to the type of transportation used, e.g., airplane, automobile, foot, boat, and train, to traverse a travel route, e.g., a list of geolocation data points presented in a sequential manner to get to a POI from a starting point. As an example, an interstate highway may indicate an automobile travel mode, and a travel route that is conducive to the automobile travel mode for traversing from one continental state to another.

In addition to, or in substitute of, site identity, a list of other electromagnetic sources may be maintained to aid in the determination of travel modes or routes, such as, e.g., Wi-Fi access points, beacons, system management radios, or other emitters. Geolocation data provided by the devices may comprise electromagnetic source information that may be mapped. For example, radio protocols or frequency bands associated with metropolitan bus travel, such as, e.g., radio resources employed by buses and/or bus routing systems, may be used to infer a bus travel mode or route. Similarly, radio protocols or frequency bands associated with railway travel, such as, e.g., radio resources employed by railway systems, may be used to infer a railway travel mode or route.

In addition to, or in substitute of, coordinates data, a list of geofence areas may be maintained to aid in the determination of travel modes or routes, such as, e.g., a park and recreation geofence area may be associated with a footpath travel mode or route, and an highway geofence area may be associated with a highway travel mode or route. If the location or coordinates of the geolocation data matches within a certain geofence area, then the corresponding travel mode or route may be assumed.

The travel modes or routes may be further sorted or verified based on inferred speed of travel after analyzing timestamps associated with a plurality of geolocation data, such as, e.g., associating travel modes or routes when inferred speed is above, below or between predefined thresholds. As examples, an inferred speed of travel of over 50 MPH may be designated as a highway travel route; an inferred speed of travel of less than 10 MPH may be designated as a footpath travel route; an inferred speed of travel between 10 and 50 MPH may be designated as a railway travel route; and an inferred speed of travel above 300 MPH may be designated as an aerial travel route.

The sorting of device identity, site identity, coordinates data, and/or a timestamp data may comprise a predefined weighting structure that assigns priorities for each category. For example, device identity may be given the highest priority, e.g., a device identity pertaining to an on-board vehicle device may be given more weight when compared with coordinates that may indicate a walking trail. Further, each travel mode or route may comprise its own weighting structure. For example, an aerial travel mode or route may favor timestamp data and/or speed data derived from the timestamp data over site identity. A scoring rubric may be implemented based on the weighting structure to determine a ranking of travel modes or routes, e.g., most likely and least likely mode or route, when more than one is possible.

The analysis may also sort the geolocation data to determine traffic flow at the destinations, such as, e.g., at intersections of the destinations. For example, a large amount of clustered geolocation data points may indicate high traffic flow, while a small amount of clustered geolocation data points may indicate low traffic flow. Other information pertaining to a destination that can be extrapolated from the analysis include, e.g., the amount of traffic flow per day, dates most desired, intersections most used, and traffic flow at particular times during the day. In addition, road type, such as, e.g., one-way streets, turn prohibitions, and etc., may be determined from the traffic flow data.

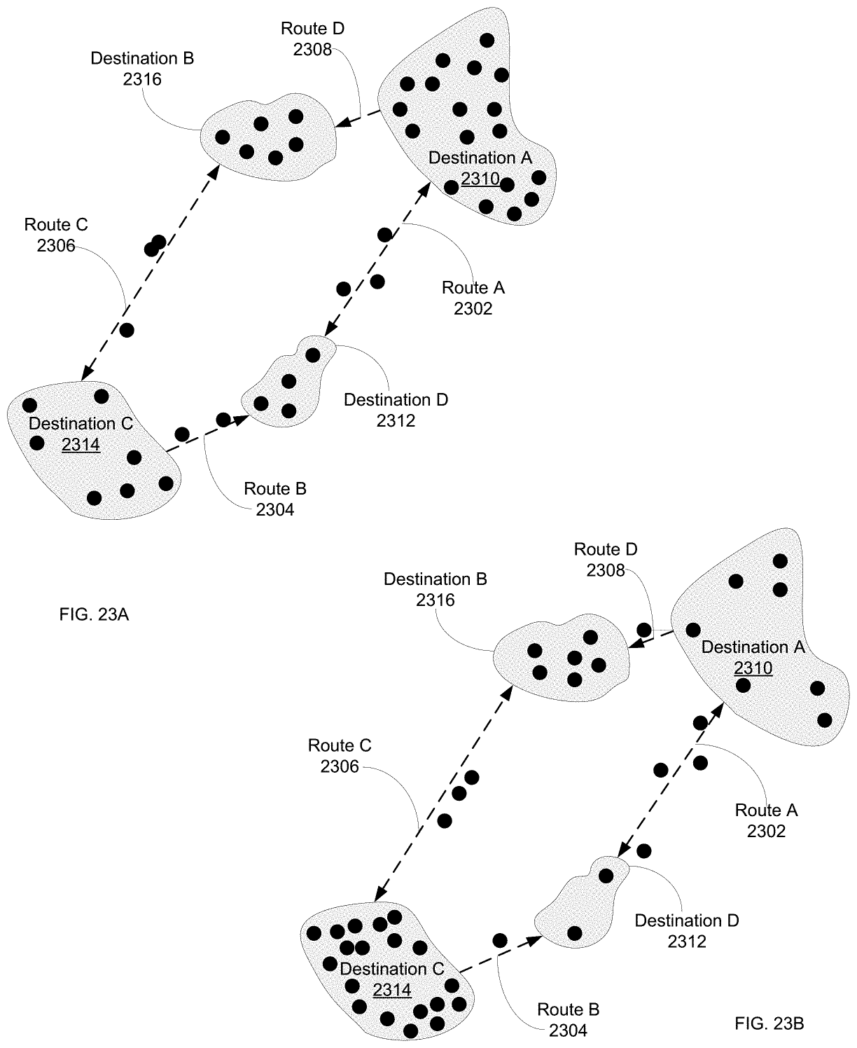

FIGS. 23A-B are diagrams of geolocation clusters associated with a plurality of devices. A geolocation data point, or location fix, is represented by a black dot and may be created by a communication event, such as, e.g., a transmission from a mobile, machine or vehicle device to a cellular network, or vice versa. Each geolocation data point may comprise a location, which may be a proxy for the approximate location of the mobile, machine, or vehicle device, and a timestamp. Telematics data may also be collected from one or more external vendors.

In FIG. 23A, a map may comprise travel route A 2302, travel route B_04, travel route C 2306, and travel route D 2308. Route A 2302 may connect destination A 2310 and destination D 2312; route B 2304 may connect destination D 2312 and destination C 2314; route C 2306 may connect destination C 2314 and destination B 2316; and route D 2308 may connect destination B 2316 and destination A 2310. Route A 2302 and route C 2306 may be bi-directional, while route B 2304 and route D 2308 may be unidirectional, indicated by the arrows. Each of destination A 2310, destination B 2316, destination C 2314, and destination D 2312 may comprise clusters of a plurality of geolocation data points representing the aggregation of human beings and/or autonomous vehicles and machines at those areas. Geolocation data points that fall within a vicinity of route A 2302, route B 2304, route C 2306, and route D 2308 may be indicative of traffic flow moving from one area to another.

FIG. 23B is the same map as FIG. 23A captured at a later point in time, e.g., timestamp. By analyzing and comparing geolocation data of both figures, traffic flow from one area to another can be determined. In addition, the travel mode for route A 2302, route B 2304, route C 2306, and route D 2308 may be inferred based on device identity, site identity, coordinates, and/or timestamp data of the geolocation clusters.

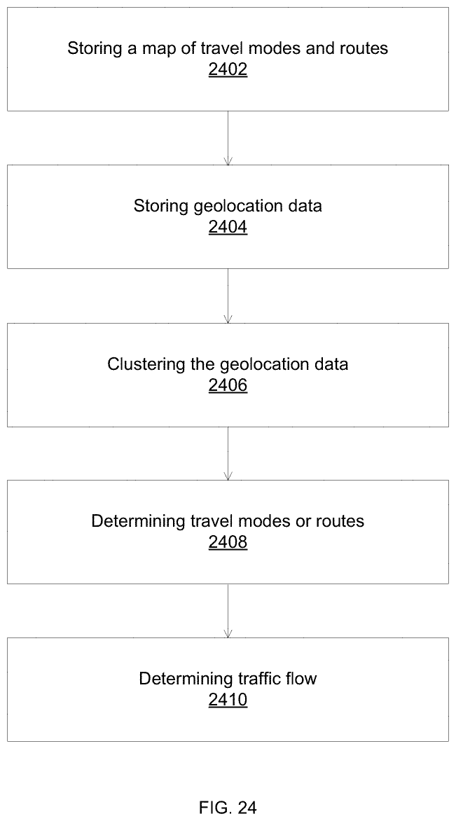

FIG. 24 is a flow diagram of a method for determining or verifying travel mode, route, and/or traffic flow at a destination. Operation 2402 stores a map of travel modes or route at a first data store, such as, e.g., a roadway, a railway, aerial travel, marine travel, submarine travel, or a footpath, for reaching one or more destinations. Operation 2404 stores geolocation data associated with a plurality of mobile devices and/or vehicle devices comprising, e.g., device identity, site identity, coordinates, and/or timestamp, information. Operation 2406 clusters the plurality of geolocation data onto the map of travel modes or routes. Operation 2408 determines travel mode or route traversed by the mobile, machine, and/or vehicle devices based on the clustering of the geolocation data. As examples, a cluster of device identities that matches vehicle devices may infer a roadway travel mode or route using automobiles; a cluster of site identities that matches with a subway station site identity may infer a subway travel mode or route; a cluster of coordinates data matching mountainous terrain may infer a footpath travel mode or route; and a cluster of timestamp data matching a flight schedule may infer an aerial travel mode or route. In addition, travel mode or route may be inferred based on of how the device is carried, such as, e.g., an individual carrying a mobile device while traveling in a vehicle may be distinguished from an individual carrying a mobile device while walking based upon whether the device is plugged into a power source.

In addition to, or in substitute of, site identity, a list of other electromagnetic sources may be maintained to aid in the determination of travel modes or routes, such as, e.g., Wi-Fi access points, beacons, system management radios, or other emitters. Geolocation data provided by the devices may comprise electromagnetic source information that may be mapped. For example, radio protocols or radio frequency bands associated with metropolitan bus travel, such as, e.g., radio resources employed by buses and/or bus routing systems, may be used to infer a bus travel mode or route. Similarly, radio protocols or radio frequency bands associated with railway travel, such as, e.g., radio resources employed by railway systems, may be used to infer a railway travel mode or route.

In addition to, or in substitute of, coordinates data, a list of geofence areas may be maintained to aid in the determination of travel modes or routes, such as, e.g., a park and recreation geofence area may be associated with a footpath travel mode or route, and an highway geofence area may be associated with a highway travel mode or route. If the location or coordinates of the geolocation data matches within a certain geofence area, then the corresponding travel mode or route may be assumed. Direction of travel of the mobile device and/or vehicle device may also be inferred from analyzing a plurality of geolocation data. For example, an opposite direction of travel on a one-way bus route may indicate that the travel mode or route is not a known bus route, such as, e.g., an automobile route.

The travel modes or routes may be further sorted or verified based on inferred speed of travel after analyzing timestamps associated with a plurality of geolocation data, such as, e.g., associating travel modes or routes when inferred speed is above, below or between predefined thresholds. As examples, an inferred speed of travel of over 50 MPH may be designated as a highway travel route; an inferred speed of travel of less than 10 MPH may be designated as a footpath travel route; an inferred speed of travel between 10 and 50 MPH may be designated as a railway travel route; and an inferred speed of travel above 300 MPH may be designated as an aerial travel route.

The sorting of device identity, site identity including other electromagnetic source information, coordinates data including geofence data and inferred direction of travel when a plurality of data is retrieved, and/or a timestamp data including inferred speed data, may comprise a predefined weighting structure that assigns various priorities for each category. For example, device identity may be given the highest priority, e.g., a device identity pertaining to an on-board vehicle device may be given more weight when compared with coordinates that may indicate a walking trail. Further, each travel mode or route may comprise its own weighting structure. For example, an aerial travel mode or route may favor timestamp data and/or speed data derived from the timestamp data over site identity. A scoring rubric may be implemented based on the weighting structure to determine a ranking of travel modes or routes, e.g., most likely and least likely mode or route, when more than one is possible.

Operation 2410 determines traffic flow at the one or more destinations based on the clustering of the geolocation data. The amount of clustered geolocation data points may be proportionally related to traffic flow. For example, a large amount of clustered geolocation data points may indicate high traffic flow, while a small amount of clustered geolocation data points may indicate low traffic flow. Other information pertaining to a destination that can be extrapolated from the analysis include, e.g., the amount of traffic flow per day, road type, dates most desired, intersections most used, and traffic flow at particular times during the day.

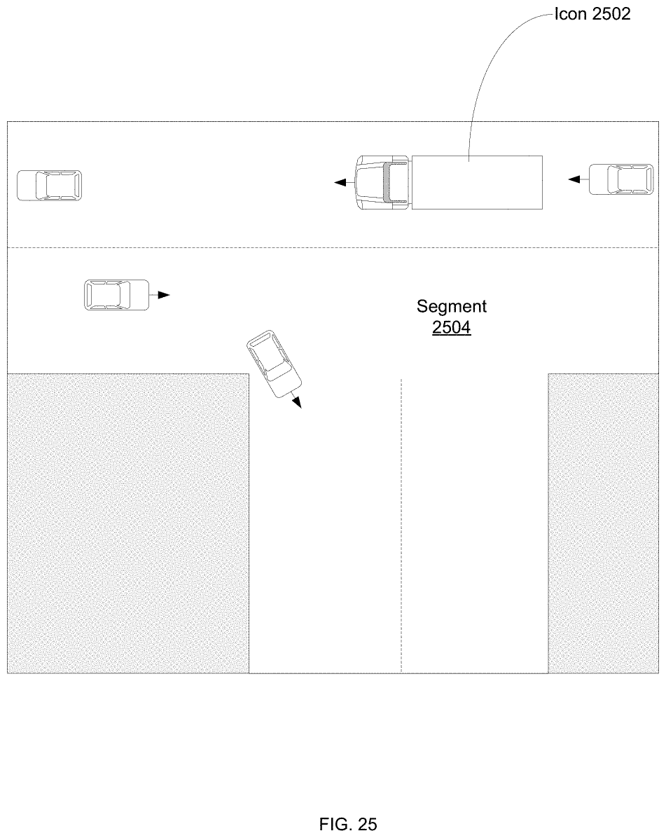

FIG. 25 is a schematic diagram of a map comprising GPS data on a two-way street.

Each data point may be represented by vehicle icon 2502 traveling on a road or road segment 2504; however, any other visual representation may be used, such as, e.g., an arrow or a dot. Each icon 2502 may be distinguished by the type of mobile, machine, or vehicle device identity obtained from the data that it is associated with, such as, e.g., an image of a big rig, sedan, motorcycle, pedestrian, bus, light rail, aircraft, watercraft, or submarine. Icon 2502 may be associated with other data, such as, e.g., speed, location, and direction of travel. The direction of travel may be indicated by an arrow, such as, e.g., an arrowing pointing west indicates a westward direction of travel, and/or by icon 2502's orientation, such as, e.g., an automobile facing east indicates an eastward direction of travel.

Traffic flow visualization of GPS data samples on a map may permit inference and/or verification of information about road or road segment 2504, such as, e.g., direction of travel, speed, road type, and/or travel mode, on the road or road segment 2504. For example, by analyzing direction of travel of GPS data represented by icon 2502, the presence and detection of one-way or two-way road or road segment 2504 can be determined. If a sampling of data shows a plurality of icon 2502 consisting of two directions of travel, then road or road segment 2504 can be inferred or verified as a two-way path; if a sample of data shows a plurality of icon 2502 consisting of one direction of travel, then a road or road segment 2504 can be inferred or verified as a one-way path. In this figure, road or road segment 2504 is illustrated as a two-way path because a plurality of icon 2502 is shown in two directions of travel, one opposite the other. In some cases, additional indicators may be used to infer or verify that road or road segment 2504 is truly a two-way or one-way path, such as, e.g., by satellite or digital images, and/or street sign data. If there is conclusive evidence of a two-way or one-way path, a user or an automatic algorithm may mark road or road segment 2504 accordingly. In addition, travel modes and routes pertaining to a particular road or road segment 2504 may also be inferred or verified. In some cases, automatic inference or verification of road or road segment 2504 and/or travel modes or routes associated with road or road segment 2504 may occur when a percentage of data samples indicate accordingly. For example, road or road segment 2504 may be automatically flagged as a two-way street if roughly half, e.g., 40-60 percent of the data samples associated with road or road segment 2504 is represented as having a particular direction of travel and the remaining data samples associated with road or road segment 2504 have an opposite direction of travel.

Other applications that traffic flow visualization can provide includes the determination of the average speed and usage amount of road or road segment 2504. For example, average speed may be calculated from a plurality of GPS data points, which the user or algorithm may label on the map. Each data point may be represented by vehicle icon 2502 traveling on a road or road segment 2504; however, any other visual representation may be used, such as, e.g., an arrow or a dot. Usage information may be deduced from the amount of icon 2502 representing mobile devices or vehicle devices associated with, and displayed on, road or road segment 2504. For example, a map display of hundreds or thousands of icon 2502 associated with a particular road or road segment 2504 within a fixed, relatively short period of time may indicate that the road has heavy traffic during the time period. Certain road or road segment 2504 may have fewer associated samples of data. This may indicate that motorists rarely use this pathway and may not be a preferred route. A priority system may be established to recommend routes for route guidance, such as, e.g., preferred routes may be given a higher priority over routes that are infrequently used. High priority routes may be preferred over low priority routes when being recommended to a mobile, machine, and/or vehicle device, or when combining with other routes to establish a new route.

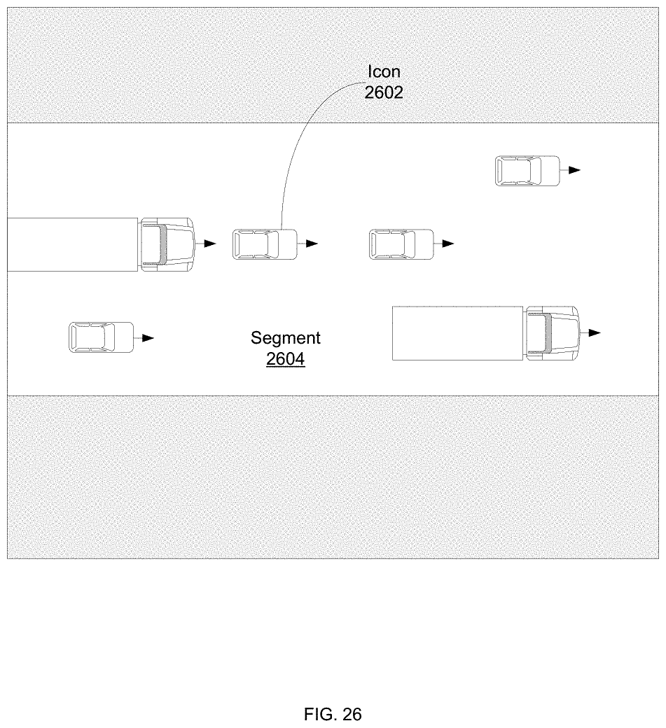

FIG. 26 is a schematic diagram of a map comprising GPS data on a one-way street. Each data point may be represented by vehicle icon 2602 traveling on a road or road segment 2604; however, any other visual representation may be used, such as, e.g., an arrow or a dot. Each icon 2602 may be distinguished by the type of mobile, machine, or vehicle device identity obtained from the data that it is associated with, such as, e.g., an image of a big rig, sedan, motorcycle, pedestrian, bus, light rail, aircraft, boat, or submarine. Icon 2602 may be associated with other data, such as, e.g., speed, location, and direction of travel. The direction of travel may be indicated by an arrow, such as, e.g., an arrowing pointing west indicates a westward direction of travel, and/or by icon 2602's orientation, such as, e.g., an automobile facing east indicates an eastward direction of travel.

A one-way path may be differentiated from a two-way path when a percentage or majority, such as, e.g., over 50-percent, of icon 2602 is oriented in the same direction. The remaining minority amount of icon 2602 oriented in the opposite direction may be attributed to, e.g., a vehicle moving in reverse such as to park, a pedestrian traveling in the opposite direction of traffic, and/or a vehicle traveling the wrong way. A user, or an automatic algorithm, of the map may infer or verify road or road segment 2604 as a potential one-way path. In some cases, automatic identification of a possible one-way path may occur when a predetermined minimum threshold amount, or percentage, of data samples indicate the same direction of travel. For example, road or road segment 2604 may be automatically flagged as a one-way path if there are greater than 50 data samples, and/or if greater than 70-percent of the data samples are associated with road or road segment 2604 is represented as having the same direction of travel.

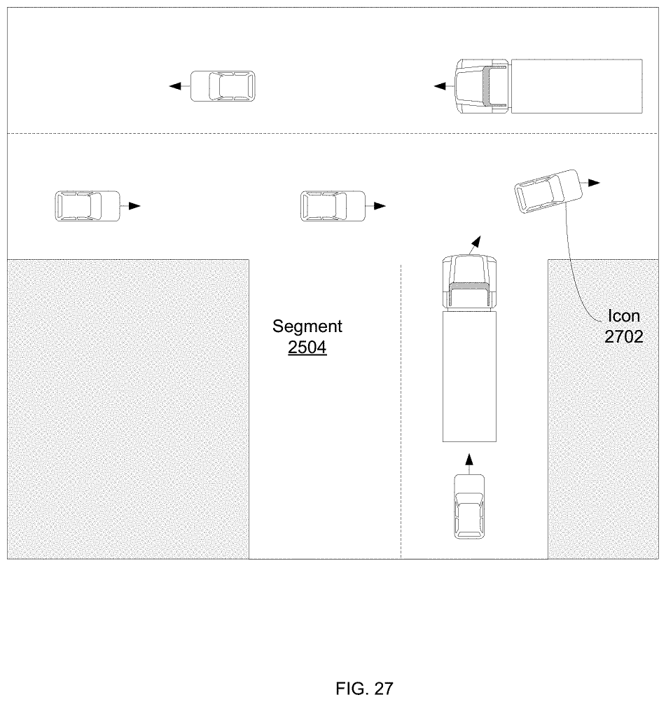

FIG. 27 is a schematic diagram of a map comprising GPS data on a turn-restricted path. Each data point may be represented by vehicle icon 2702 traveling on a road or road segment 2704; however, any other visual representation may be used, such as, e.g., an arrow or a dot. Each icon 2702 may be distinguished by the type of mobile device, machine, or vehicle device identity obtained from the data that it is associated with, such as, e.g., an image of a big rig, sedan, motorcycle, pedestrian, bus, light rail, aircraft, boat, or submarine. Icon 2702 may be associated with other data, such as, e.g., speed, location, and direction of travel. The direction of travel may be indicated by an arrow, such as, e.g., an arrowing pointing west indicates a westward direction of travel, and/or by icon 2702's orientation, such as, e.g., an automobile facing east indicates an eastward direction of travel.

The direction of turns associated with and intersection of road or road segment 2704 may be used to infer or verify the presence of turn restrictions. For example, when a percentage or majority, e.g., over 70%, of icon 2702 is depicted having turns pointing in one particular direction and not the other, the intersection may be determined to have a turn restriction in the opposite direction. A user, or an automatic algorithm, of the map may mark or label the intersection as possibly having a turn restriction. In some cases, additional indicators may be used to infer or verify the turn restriction, such as, e.g., by satellite or digital images, and/or street sign data.

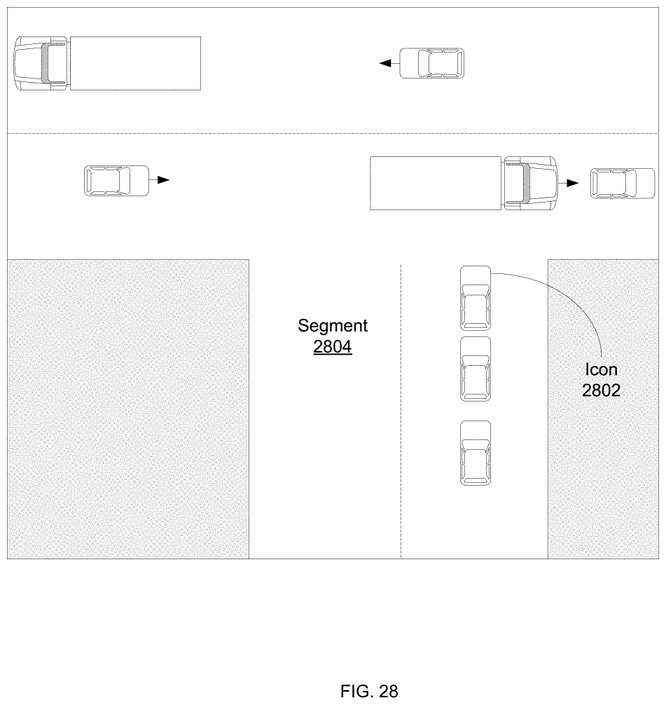

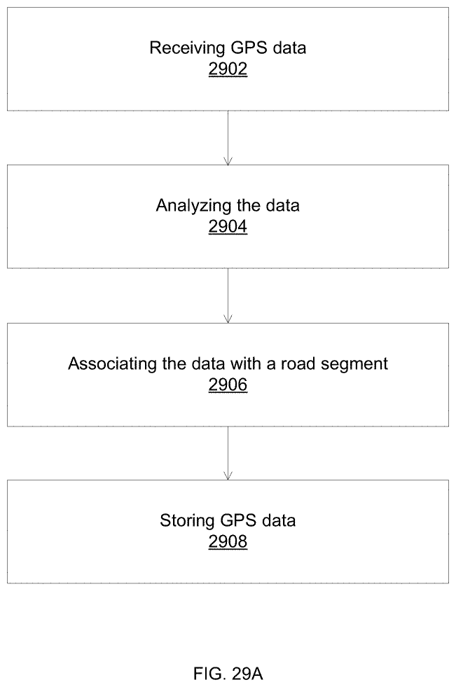

FIG. 28 is a schematic diagram of a map comprising GPS data with the presence of a stop signal. A stop signal may be a stop light or sign disposed at an intersection. Each data point may be represented by vehicle icon 2802 traveling on a road or road segment 2804; however, any other visual representation may be used, such as, e.g., an arrow or a dot. Each icon 2802 may be distinguished by the type of mobile device or vehicle device identity obtained from the data that it is associated with, such as, e.g., an image of a big rig, sedan, motorcycle, pedestrian, bus, light rail, aircraft, watercraft, or submarine. Icon 2802 may be associated with other data, such as, e.g., speed, location, and direction of travel. The direction of travel may be indicated by an arrow, such as, e.g., an arrowing pointing west indicates a westward direction of travel, and/or by icon 2802's orientation, such as, e.g., an automobile facing east indicates an eastward direction of travel.

Samples of GPS data may be collected in succession over a period of time, which may indicate that one or more icon 2802 has stopped at an intersection. For example, if a predetermined minimum threshold amount, or percentage, of data samples indicates that a plurality of icon 2802 is stopped at a certain intersection, the intersection comprises a possible stop signal. In addition, the average length of time that icon 2802 remain stopped, and the regularity of the stopped period may be taken into consideration, such as, e.g., data samples indicating traffic remained stopped at a given intersection on average for 60 seconds, followed by 60 seconds in which few devices are stopped, may indicate that there is a stop light that is cycling through red and green lights every 60 seconds. A user, or an automatic algorithm, of the map may mark or label the intersection as possibly having a stop signal. In some cases, additional indicators may be used to infer or verify the turn stop signal, such as, e.g., by satellite or digital images, and/or street sign data.

One or more maps may be generated and display representation of geolocation data, e.g., GPS data, associated with the mobile devices, machines, and/or and vehicles. The GPS data may be embodied as a representation having descriptive features that visually indicate the location, direction of travel, and speed of travel of the mobile, machine and/or vehicle devices associated with one or more road segments on a map. The display of the GPS data may be used for guiding a driver on a route, editing information about roads, and determining usage, such as, e.g., preferred routes, whether the road is a one-way street, the average speed of vehicles on the road, the presence of turn restrictions at an intersection, and the location of stop signals. These determinations may be made algorithmically by aggregating big data for one or more road segments, or ad hoc by a human observer based on judgment.

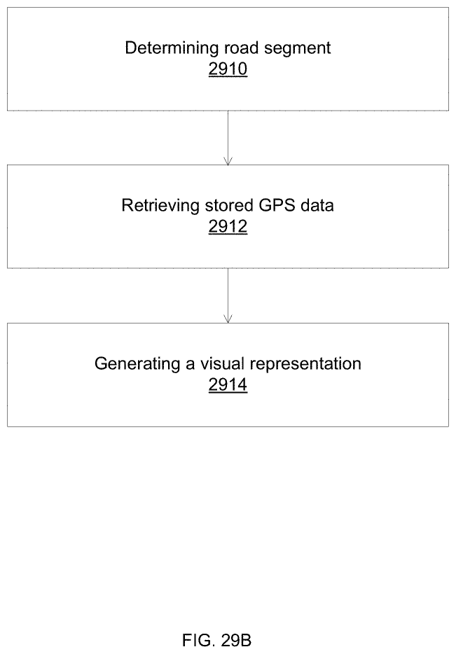

FIGS. 29A-B are flow diagrams for a method of visualizing GPS data. FIG. 29A depicts a data collection stage, and FIG. 29B shows a data display stage, which may be performed synchronously or asynchronously, such as, e.g., a large number of GPS data sample may be collected and then subsequently displayed as needed, or both stages may operate in parallel. Operation 2902 receives GPS data from a mobile, machine, and/or an on-board vehicle device. Data may also be collected from one or more external vendors. The data may include a device identity associated with the device, a site identity of a cellular network communicatively coupled with the device including other electromagnetic source information, coordinates data of the device, and/or a timestamp data. The GPS data may be received at a specific upload pattern, such as, e.g. at regular intervals of distance, or periodically based on unit of time. Alternatively, location points may be collected in response to requests sent from a server, such as, e.g., at each destination or stop. A destination or stop can be detected when the device has not changed location for a predetermined amount of time, or by input from the user or driver. Operation 2904 analyzes the data, such as, e.g., to determine whether the device, vehicle or machine is located within a known geofence based on coordinates data, direction of travel when a plurality of data is retrieved based on coordinates data, and inferred speed when a plurality of data is analyzed based on timestamps.

Operation 2906 associates the GPS data with a road or road segment on a map. A road segment may be, e.g., a portion of a road between two adjacent intersections, and/or defined by a specific length. The received trajectory data may be matched with a map, such as, e.g., incoming trajectory data may be aligned to a road or road segment based on characteristic information of the road or road segment, such as, e.g., whether the road is a highway, residential street, or two or three lane road. The map-matching process may consider both the geographic location and heading of the navigation device in the vehicle or on the traveler, such as, e.g., by comparing the distance between the trajectory data and the road or road segment, as well as a heading value of the navigation device and heading value of the road or road segment. In order to associate a GPS sample to a road or road segment, a plurality of segments may be compared. For example, a best fit score corresponding to an association with one road or road segment is compared to a second best fit score corresponding to an association with another road or road segment. If the difference between the best fit score and second best fit score meets or exceeds a predetermined threshold, the GPS sample may be associated with the road or road segment with the best fit score.

Operation 2908 stores the GPS data in a data store, such as, e.g., an internal or external server. Samples of data may be stored for an indefinite period of time to be displayed on a map at a later time. In some cases, storing of the data may be performed in conjunction with associating it with a road or road segment. The operations of data collection in FIG. 29A may be repeated with respect to a large number of mobile, machine and/or vehicle devices over an predetermined period of time, such as, e.g., an hour, a day, or a week, depending on the application for which the collected information is to be used. For example, an administrator may configure the collections of hundreds or thousands of data samples from numerous devices through a given roadway or intersection over a period of time in order to determine traffic patterns at the location. In addition, the individual steps of data collection may be performed synchronously or asynchronously from each other when collecting large sample sizes. For example, a large number of data may be first collected and stored, and then subsequently processed at a later time. Similarly, multiple threads may be operating in parallel to collect, analyze, associate and store the data

In FIG. 29B, operation 2910 determines a road segment to be displayed on a map of a graphical user interface. Operation 2912 retrieves stored GPS data pertaining to the selected road segment. Operation 2914 generates a visual representation of each retrieved GPS data associated with the road segment, such as, e.g., an arrow, a dot, or another icon. The operations of FIG. 27B may be repeated for each road segment to be displayed on a map.

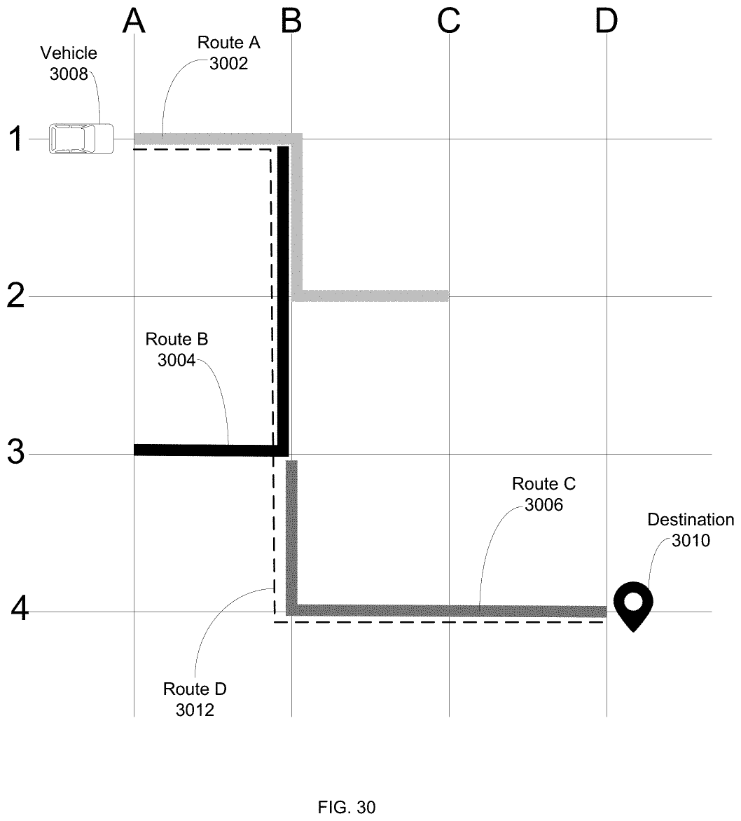

FIG. 30 is a sample map on which routes may be traveled. These routes are used to demonstrate various aspects of how known routes may be combined to provide a new set of directions. Information may be collected continually based on routes that people actually travel, and may be stored in a data store. When there is no complete route from point a starting to an ending destination in storage, routes that do exist in storage may be patched together to create a complete route, as long as they overlap with each other in ways that meet certain properties. The map may be shown as a rectangular grid with streets at right angles; however, it will be understood that a map could be any set of streets that follow paths of any shape, and that intersect in any manner. The routes may use any available road or path including, for example, freeways, surface streets, toll roads, sidewalks, bridges, tunnels, or undefined roads, such as, e.g., unpaved dirt or gravel roads. The map may comprise horizontally numbered streets, such as, e.g., 1^{st} street to 4^{th} street, and vertically lettered or alphabetical streets, such as, e.g., A street to D street. A route could be known through any mechanism, such as, e.g., a person has actually been observed to travel along the route, a digitally calculated route, or it may be a stored route. For example, travelers may opt-in to having their device continually determine their location and to have this information collected by a service. Since the information collected represents actual routes, it provides continual verification of, e.g., turns that appear on a map which can be made in real life, duration to travel the routes, how travel time and availability of turns correlates with the time of day and the number of people in a vehicle, and other factors. In addition, this can provide a higher level of accuracy for data analysis as compared with purely simulated data. Actual route and vehicle data may account for driver behavior, road obstacles, signage, vegetation, vehicle characteristics, and other factors that may not be able to be captured otherwise. When a database of routes is collected, the database may be used to respond to requests for directions. If the route is stored, it may be retrieved and provided as directions. A “leg” may be defined as a portion of a route for which there is no possibility of turning off the route. Each turn may permit a mobile, machine, and/or vehicle device to connect from one leg to the other at an intersection of two or more streets.

Route A 3002 may start at 1^{st} street and A street, and ends at 3^{rd} street and C street. Route A 3002 may comprise three legs depicted as joining line segments, and two turns depicted at the juncture of the joining line segments. Its first leg begins at 1^{st} street and A street and ends at 1^{st} street and B street, its second leg begins at 1^{st} street and B street and ends at 2^{nd} street and B street, and its third leg begins at 2^{nd} street and B street and ends at 2^{nd} street and C street; its first turn is at 1^{st} street and B street.

Route B 3004 may start at 1^{st} street and B street, and ends at 3^{rd} street and A street. Route B 3004 may comprise two legs depicted as joining line segments, and one turn depicted at the juncture of the joining segments. Its first leg begins at 1^{st} street and B street and ends at 3rd street and B street, and its second leg begins at 3rd street and B street and ends at 3^{rd} street and A street.

Route C 3006 may start at 3^{rd} street and B street, and ends at 4th street and D street. Its turn is at 3^{rd} street and B street. Route C 3006 may comprise two legs depicted as joining line segments, and one turn depicted at the juncture of the joining segments. Its first leg begins at 3^{rd} street and B street and ends at 4^{th} street and B street, and its second leg begins at 4^{th} street and B street and ends at 4^{th} street and D street. Its turn is at 4^{th} street and B street.

Vehicle 3008 may begin its journey from 1^{st} street and A street to reach destination 3010 at 4^{th} street and D street. Although the vehicle is shown as a car, by way of example, it could be of any type, such as, e.g., a bus, truck, motorcycle, bicycle, aircraft, maritime vessel, or even a pedestrian. It is observed that there is no single known route that actually runs from 1^{st} street and A street to reach destination 3010 at 4^{th} street and D street; however, portions that are in common, e.g., legs, turns, and/or intersections, of route A 3002, route B 3004, and route C 3006 may be combined to accomplish such goal. Route A 3002 may have a leg in common with a portion of a leg of route B 3004, such as, e.g., from 1^{st} street and B street to 2^{nd} street and B street, and thus may be combined. Vehicle 3008 may begin trip at 1^{st} street and A street, and then proceed through this combine leg portion to the intersection of 3rd street and B street. This intersection may be shared in common between route B 3004 and route C 3006, and is thus combined. Vehicle 3008 may then proceed to 4^{th} street and B street before turning on route C 3006 to proceed to destination 3010 at 4th street and D street. Route A 3002's leg from 2^{nd} and B street to 2^{nd} and C street, and route B 3004's leg from 3^{rd} street and B street to 3^{rd} street and A street may be omitted out of the combination of new route. As such, vehicle 3008 may traverse newly combined route D 3012, indicated by broken lines. In cases where a plurality of routes may be combined to achieve the same endpoint, preferred routes, e.g., heavily used routes, and/or lower cost routes, e.g., less expensive routes, may be prioritized. The process may first look for a long route, and then may look for successively smaller routes to be patched together until a complete set of directions is created. In general, longer routes may be considered more informative, since it represents a larger set of decisions, made by an actual person, about how to get from one point to another. Longer routes may also simplify and speed the routing process, since a longer route may cover a significant portion of the distance from one point to another; thereby reducing the amount of splicing that would have to be done if shorter routes are used.

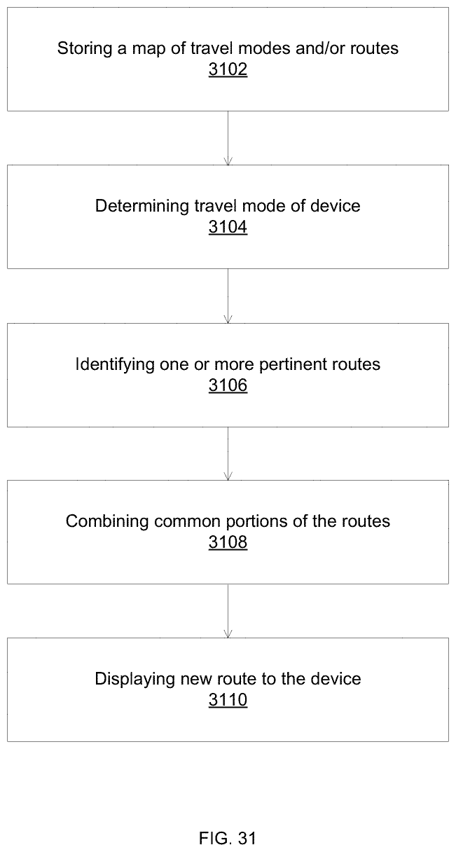

FIG. 31 is a flowchart of a method for creating a new route through a plurality of known routes. Operation 3102 stores a map of travel modes and/or routes at a data store, such as, e.g., a roadway, a railway, aerial travel, marine travel, submarine travel, or a footpath, for reaching one or more destinations. Operation 3104 determines the travel mode of a mobile, machine, and/or vehicle device based on one or more of a, e.g., device identity, site identity, coordinates data, and/or timestamp data, and according to the operations of FIG. 24.

Operation 3106 identifies one or more pertinent routes for reaching a destination of the device, such as, e.g., a delivery job destination, an event venue, a business location, a dining area, a home, or any other location. The received trajectory data may be matched with a route of a map, such as, e.g., incoming trajectory data may be aligned to a road or road segment based on characteristic information of the road or road segment, such as, e.g., whether the road is a highway, residential street, or two or three lane road. The map-matching process may consider both the geographic location and heading of the navigation device in the vehicle or on the traveler, such as, e.g., by comparing the distance between the trajectory data and the road or road segment, as well as a heading value of the navigation device and heading value of the road or road segment. In order to associate a GPS sample to a route, a plurality of segments may be compared. For example, a best fit score corresponding to an association with one route is compared to a second best fit score corresponding to an association with another route. If the difference between the best fit score and second best fit score meets or exceeds a predetermined threshold, the GPS sample may be associated with the route with the best fit score.

A route could be known through any mechanism, such as, e.g., a person has actually been observed to travel along the route, a digitally calculated route, or it may be a stored route. For example, travelers may opt-in to having their device continually determine their location and to have this information collected by a service. Since the information collected represents actual routes, it provides continual verification of, e.g., turns that appear on a map which can be made in real life, duration to travel the routes, how travel time and availability of turns correlates with the time of day and the number of people in a vehicle, and other factors. In addition, this can provide a higher level of accuracy for data analysis as compared with purely simulated data. Actual route and vehicle data may account for driver behavior, road obstacles, signage, vegetation, vehicle characteristics, and other factors that may not be able to be captured otherwise. When a database of routes is collected, the database may be used to respond to requests for directions. If the route is stored, it may be retrieved and provided as directions.

Operation 3108 combines common or overlapping portions, e.g., legs, turns, and/or intersections, of the routes to create a new route if no known single route exists. In cases where a plurality of routes may be combined to achieve the same endpoint, preferred routes, e.g., heavily used routes, and/or lower cost routes, e.g., less expensive routes, may be prioritized. The process may first look for a long route, and then may look for successively smaller routes to be patched together until a complete set of directions is created. In general, longer routes may be considered more informative, since it represents a larger set of decisions, made by an actual person, about how to get from one point to another. Longer routes may also simplify and speed the routing process, since a longer route may cover a significant portion of the distance from one point to another; thereby reducing the amount of splicing that would have to be done if shorter routes are used. Operation 3110 displays the new route to the device.

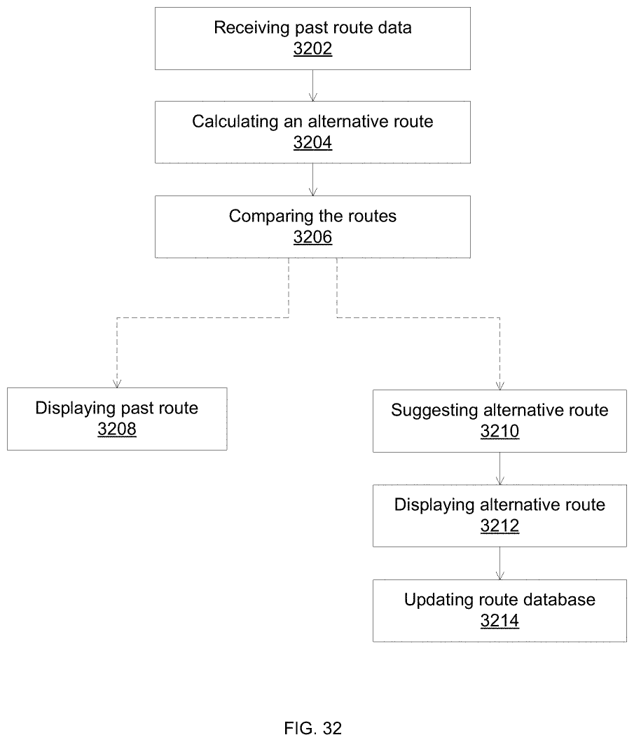

FIG. 32 is a flowchart of a method for comparing a past route with an alternative route based on one or more criteria, such as, e.g., the cost or expense associated with traveling a route, travel time, time-of-day, and/or distance. The alternative route may be computed by the platform, and if it is more beneficial to a user of a mobile, machine, or vehicle device, such as, e.g., less expensive to traverse, then the route may be suggested to the user or an administrator of a fleet operation. Operation 3202 receives past route data for traversing at a point of origin to reach a destination with a mobile, machine, and/or vehicle device. Past route data may be obtained through the operations of FIG. 21, and pertaining to the relevant travel mode, such as, e.g., a roadway, a railway, aerial travel, marine travel, submarine travel, or a footpath, as described in the operations of FIG. 24. Operation 3204 calculates one or more alternative routes based on collected data, such as, e.g. route data or characteristics, and/or vehicle data including telematics sensory data. An alternative route may be a new route that is not found in an existing database, such as a newly formed route through the operations of FIG. 31, and may be optimized for one or more predetermined factors, such as, e.g., cost, travel time, and/or distance.

Examples of route data that impacts cost include, e.g. duration, distance, speed limit, speed bumps, forecasted traffic data, road obstacles, whether roads are paved, schools and/or construction zones, presence of toll booths, traffic lights, signage, and topology such as uphill and/or downhill grades. Generally, longer travel duration and/or distance may be more expensive than shorter travel duration and/or distance. The time associated with making each turn may be taken into account in calculating the overall cost since traveling down a straight road in the absence of traffic is relatively quick, and much of the time spent traveling a route may be spent in the turns. Different costs may be calculated for different times of day the route was taken as the amount of traffic present may vary. The number of passengers in a vehicle at the time the route was traversed may also impact cost of a route because there may be, e.g., lane restrictions and/or toll charges, to which it is dependent from. In some cases, a route complexity score may be assigned based on the foregoing, such as, e.g. a high complexity score is associated with routes that have more turns, changes in orientation, accelerations, decelerations, changes in speed, and other driving events that are inherently more risky than driving at a single speed along a straight road. For example, a route along a straight highway with little traffic is less complex than a route through the center of a densely trafficked city. The complexity data may be based on vehicle data, such e.g., certain terrains may be have different complexity ratings when comparing light vehicles against heavy vehicles. Route cost may be directly proportional to its complexity score.

Examples of vehicle data including telematics sensory data that impacts cost include, e.g., vehicle specification, vehicle age or condition, and driving behavior. Vehicles that produce more engine power, heavier, and/or older may contribute to cost through fuel usage and maintenance expense. In addition, tall vehicles may have difficult going under certain overpasses; long vehicles may have difficulty making certain turns; and commercial trucks may have to stop at weight stations. Driving behaviors that increases cost includes, e.g., frequent deceleration and acceleration events, which may add to expense due to additional fuel usage and maintenance of the vehicle. Certain behaviors also increases wear-and-tear and cost of vehicle maintenance, such as, e.g., excessive or insufficient speed, rapid deceleration and acceleration events, excessive speed in a curve, acceleration before a curve, over-braking before exiting a curve, and harsh steering maneuvers. Rapid deceleration and acceleration may be classified as an indication of a change in speed that exceeds a predetermined reference threshold over a given time duration. Harsh steering maneuvers may be classified a fast change of direction, or an indication of a number of steering adjustments that exceeds a predetermined reference threshold over a given time duration. Curve over-braking may be classified as an indication of a number of hard and/or long braking instances that exceeds a predetermined reference threshold over a given time duration while the steering angle exceeds a predetermined reference number of degrees. Excessive speed in a curve may be classified as an indication of direction change that is over the acceptable rate corresponding to acceleration.

In some cases, driving behavior and the resulting machine or vehicle operation are monitored and recorded for analysis by the user, administrator, or an automatic algorithm. Periodic recordings of speed and direction of the machine or vehicle while it is being operated are used to calculate acceleration, deceleration and directional change events. Operation data from the recording devices and the calculations performed is then compared to stored reference data to determine is the machine or vehicle was abused or operated in an unsafe manner by the user, and may be outputted to a display. For example, a certain road may have a 65 mph speed limit stored as a reference value, which can be matched with a map. An alert may be generated and displayed when a fleet's machine or vehicle is operated beyond this limit, which may present an over exertion of the asset that may lead to additional maintenance and fuel costs, and/or a dangerous maneuver. In some cases, the reference value or parameter may be specific to the machine or vehicle's capabilities and specification. For example, a low-sitting sports vehicle may have an acceptable reference turning angle that is sharper, e.g., 30-degrees, compared with a large truck, e.g., 40-degrees.

Operation 3206 compares the past route with the alternative route. In some cases, each alternative route may be assigned an overall score or rating based on the comparison between the alternative route and past route. For example, the overall score or rating of the alternative route may be on a 0-10 scale, where 0 indicates a poor performance and 10 indicates a best performance. The determination of the score may take one or more analyzed factors into account, such as, e.g., cost, travel time, and/or distance. The analyzed factors may be the same or different than the predetermined factors used to optimize the alternative route. Operation_08 displays the past route to the mobile, machine, and/or vehicle device if it is more beneficial than the alternative route, such as according to the operations so FIGS. 29A-B. Operation 3210 suggests the alternative route if it is more beneficial than the past route. If there is a plurality of alternative routes, they may be suggested based on their score or rank. Operation 3212 displays the alternative route to the mobile, machine, and/or vehicle device if the user or administrator chooses the alternative route, such as, e.g., selecting it on a graphical user interface (GUI), and according to the operations so FIGS. 29A-B. Operation 3214 updates the route database with the one or more alternative routes that may not have existed. The alternative routes may then be considered a past route for future analysis.

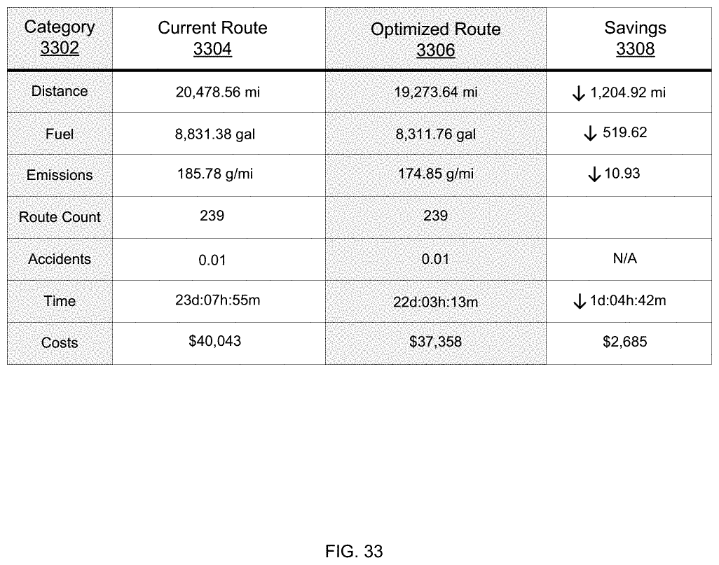

FIG. 33 is an example report produced from route and vehicle databases. The report may be prepared in a big data compatible format to enable operating expense audits, capital expense audits, and generating financial models to determine fleet savings, and may include category 3302, current route 3304, optimized route 3306, and savings 3308. Category 3302 may be parameters of measurements that can be attributed to a route, such as, e.g., distance, fuel, emissions, route count, accidents, time, and costs. Costs may include a variety of financial measurements, such as, e.g., maintenance cost, fuel cost, and/or toll cost. Current route 3304 may be a route being traveled at any present time, and optimized route 3306 may be an alternative route that is calculated by the platform. Current route 3304 and optimized route 3306 may be compared side-by-side based on the parameters of measurements listed under category 3302. Savings 3308 may reflect the difference in the measures between current route 3304 and optimized route 3306, and may include an indication of whether the alternative route is beneficial, and the quantity thereof. Through this comparison, underperforming routes may be identified based on a fleet's region, driver, and/or time period. In addition, the user or administrator may use the report for analysis to suggest possible ways to save time or money. For example, the analysis may determine that if the route is taken a few minutes later, or that if certain routes are combined, overall time and expense spent driving may be achieved.

A number of examples have been described. Nevertheless, it will be understood that various modifications may be made without departing from the spirit and scope of the claimed invention. In addition, the logic flows depicted in the figures do not require the particular order shown, or sequential order, to achieve desirable results. Other steps may be provided, or steps may be eliminated, from the described flows, and other components may be added or removed. Accordingly, other examples are within the scope of the following claims.

What is claimed is:

1. A machine-implemented method, comprising:
receiving a plurality of telematics data from at least one of a machine sensor and a third-party vendor,
wherein the telematics data comprises at least one of a sensory data and a geolocation data;
filtering the telematics data based on one or more predefined parameter, wherein the predefined parameter comprises at least one of a route data, and a vehicle data,
wherein route data comprises at least one of a road data, traffic data, and weather data; and
creating a database based on the collected telematics data.

2. The method of claim 1, further comprising:
determining financial data of a route based on the database of collected telematics data.

3. The method of claim 2, further comprising:
displaying the financial data to a user through a graphical user interface.

4. The method of claim 1, further comprising:
assigning a route complexity score based on the route data and the vehicle data.

5. The method of claim 4, further comprising:
wherein cost of a route is directly proportional to its complexity score.

6. The method of claim 1, further comprising:
analyzing the geolocation data to determine one or more vehicle data, and
wherein vehicle data comprises at least one of a speed data, coordinates data, and time data.

7. The method of claim 1, further comprising:
storing a map of a road segment.

8. The method of claim 7, further comprising:
associating the geolocation data with the road segment.

9. The method of claim 8, further comprising:
determining road data based on a matching process of map data.

10. The method of claim 9, further comprising:
determining travel mode of a device associated with the geolocation data.

11. The method of claim 10, further comprising:
calculating one or more routes for reaching a destination of the device based on the travel mode and road data.

12. The method of claim 11, further comprising:
wherein overlapping portions of two or more routes are combined to form a new route when a single route to the destination is not identified.

13. The method of claim 1, further comprising:
receiving a past route data of the device associated with the identified one or more route's origin and destination.

14. The method of claim 13, further comprising:
comparing the past route data with the identified one or more route data based on at least one criteria.

15. The method of claim 14, further comprising:
wherein the at least one criteria comprises a route cost/expense data and a time-of-day data.

16. The method of claim 15, further comprising:
displaying the past route data or the one or more route data based on the comparing of the past data and the one or more route data.

17. The method of claim 1, further comprising:
determining traffic flow data, route data, and travel mode based on clustering of geolocation data with the road segment.

18. The method of claim 17, further comprising:
wherein route data comprises road type.

19. The method of claim 17, further comprising:
analyzing the traffic flow data and the route data to modify a route.

20. A data processing system, comprising:
a processor; and
a memory coupled to the processor, the memory storing instructions which when executed by the processor causes the processor to perform a method, comprising:
receiving a plurality of telematics data from at least one of a machine sensor and a third-party vendor,
wherein the telematics data comprises at least one of a sensory data and a geolocation data;
filtering the telematics data based on one or more predefined parameter,
wherein the predefined parameter comprises at least one of a route data, and a vehicle data,
wherein route data comprises at least one of a road data, traffic data, and weather data;
creating a database based on the collected telematics data;
determining financial data of a route based on the database of collected telematics data;
displaying the financial data to a user through a graphical user interface;
assigning a route complexity score based on the route data and the vehicle data,
wherein cost of a route is directly proportional to its complexity score;
analyzing the geolocation data to determine one or more vehicle data,
wherein vehicle data comprises at least one of a speed data, coordinates data, and time data;
storing a map of a road segment;
associating the geolocation data with the road segment;
determining road data based on a matching process of map data;
determining travel mode of a device associated with the geolocation data;
calculating one or more routes for reaching a destination of the device based on the travel mode and road data,
wherein overlapping portions of two or more routes are combined to form a new route when a single route to the destination is not identified;
receiving a past route data of the device associated with the identified one or more route's origin and destination;
comparing the past route data with the identified one or more route data based on at least one criteria,
wherein the at least one criteria comprises a route cost/expense data and a time-of-day data;
displaying the past route data or the one or more route data based on the comparing of the past data and the one or more route data;
determining traffic flow data and route data based on clustering of geolocation data with the road segment,
wherein route data comprises road type; and
analyzing the traffic flow data and the route data to modify a route.
